(19) United States
(12) Patent Application Publication
(10) Pub. No.: US 2017/0199855 A1
(43) Pub. Date: Jul. 13, 2017

(54) SYSTEM AND METHOD FOR PROVIDING A TIME-BASED PRESENTATION OF A USER-NAVIGABLE PROJECT MODEL

(71) Applicant: BuilderFish, LLC, Barboursville, VA (US)

(72) Inventor: Jonathan Brandon FISHBECK, Barboursville, VA (US)

(21) Appl. No.: 14/993,027

(22) Filed: Jan. 11, 2016

(51) Int. Cl. G06F 17/24; G06T 19/00; G06T 11/60; G06F 3/0484; G06F 3/0481

(52) U.S. Cl. CPC G06F 17/241; G06F 3/04842; G06F 3/04815; G06T 11/60; G06T 19/003

(57) ABSTRACT

In some embodiments, a time-based user-annotated presentation of a user-navigable project model may be provided. Project modeling data associated with a user-navigable project model may be obtained. A time-based presentation of the user-navigable project model may be generated based on the project modeling data such that the user-navigable project model is navigable by a user via user inputs for navigating through the user-navigable project model. An annotation for an object within the user-navigable project model may be received based on user selection of the object during the time-based presentation of the user-navigable project model. The annotation may be caused to be presented with the object during at least another presentation of the user-navigable project model.

### FIELD OF THE INVENTION

The present invention relates to a time-based presentation of a user-navigable project model (e.g., navigable by a user via first person or third person view or navigable by a user via other techniques).

### BACKGROUND OF THE INVENTION

In recent years, building information modeling (BIM) has enabled designers and contractors to go beyond the mere geometry of buildings to cover spatial relationships, building component quantities and properties, and other aspects of the building process. However, typical BIM applications do not provide users with an experience that enables them to “walkthrough” and interact with objects or other aspects of a project model during a time-based presentation of a project model (that depicts how a building or other project may develop over time). In addition, BIM applications generally do not automatically modify or supplement aspects of a project model with relevant data, for example, based on user-provided annotations, action items, events, conversations, documents, or other context sources. These and other drawbacks exist.

### BRIEF SUMMARY OF THE INVENTION

An aspect of an embodiment of the present invention is to provide a system for providing a time-based user-annotated presentation of a user-navigable project model. The system includes a computer system comprising one or more processor units configured by machine-readable instructions to: obtain project modeling data associated with a user-navigable project model; generate, based on the project modeling data, a time-based presentation of the user-navigable project model such that the user-navigable project model is navigable by a user via user inputs for navigating through the user-navigable project model; receive an annotation for an object within the user-navigable project model based on user selection of the object during the time-based presentation of the user-navigable project model; and cause the annotation to be presented with the object during at least another presentation of the user-navigable project model.

An aspect of another embodiment of the present invention is to provide a system for providing a time-based user-annotated presentation of a user-navigable project model. The system includes a computer system comprising one or more processor units configured by machine-readable instructions to: obtain project modeling data associated with a user-navigable project model; generate, based on the project modeling data, a time-based presentation of the user-navigable project model such that the user-navigable project model is navigable by a user via user inputs for navigating through the user-navigable project model; receive a request to add, modify, or remove an object within the user-navigable project model based on user selection of the object during the time-based presentation of the user-navigable project model; and cause the user-navigable project model to be updated to reflect the request by adding, modifying, or removing the object within the user-navigable project model.

An aspect of another embodiment of the present invention is to provide a system for facilitating augmented-reality-based interactions with a project model. The system includes a user device comprising an image capture device and one or more processor units configured by machine-readable instructions to: receive, via the image capture device, a live view of a real-world environment associated with a project model; provide an augmented reality presentation of the real-world environment, wherein the augmented reality presentation comprises the live view of the real-world environment; receive an annotation related to an aspect in the live view of the real-world environment based on user selection of the aspect during the augmented reality presentation of the real-world environment; provide the annotation to a remote computer system to update the project model, wherein project modeling data associated with the project model is updated at the remote computer system based on the annotation; obtain, from the remote computer system, augmented reality content associated with the project model, wherein the augmented reality content obtained from the remote computer system is based on the updated project modeling data associated with the project model; and overlay, in the augmented reality presentation, the augmented reality content on the live view of the real-world environment.

An aspect of another embodiment of the present invention is to provide a system for facilitating augmented-reality-based interactions with a project model. The system includes a computer system comprising one or more processor units configured by machine-readable instructions to: receive, from a user device, an annotation for an aspect in a live view of a real-world environment associated with a project model, wherein the live view of the real-world environment is from the perspective of the user device; cause project modeling data associated with the project model to be updated based on the annotation; generate augmented reality content based on the updated project modeling data associated with the project model; and provide the augmented reality content to the user device during an augmented reality presentation of the real-world environment by the user device, wherein the augmented reality content is overlaid on the live view of the real-world environment in the augmented reality presentation.

An aspect of another embodiment of the present invention is to provide a method for providing a time-based user-annotated presentation of a user-navigable project model, the method being implemented by a computer system comprising one or more processor units executing computer program instructions which, when executed, perform the method. The method includes: obtaining, by the one or more processor units, project modeling data associated with a user-navigable project model; generating, by the one or more processor units, based on the project modeling data, a time-based presentation of the user-navigable project model such that the user-navigable project model is navigable by a user via user inputs for navigating through the user-navigable project model; receiving, by the one or more processor units, an annotation for an object within the user-navigable project model based on user selection of the object during the time-based presentation of the user-navigable project model; and presenting, by the one or more processor units, the annotation with the object during at least another presentation of the user-navigable project model.

An aspect of another embodiment of the present invention is to provide a method for providing a time-based user-annotated presentation of a user-navigable project model, the method being implemented by a computer system comprising one or more processor units executing computer program instructions which, when executed, perform the method. The method includes: obtaining project modeling data associated with a user-navigable project model; generating, based on the project modeling data, a time-based presentation of the user-navigable project model such that the user-navigable project model is navigable by a user via user inputs for navigating through the user-navigable project model; receiving a request to add, modify, or remove an object within the user-navigable project model based on user selection of the object during the time-based presentation of the user-navigable project model; and causing the user-navigable project model to be updated to reflect the request by adding, modifying, or removing the object within the user-navigable project model.

An aspect of another embodiment of the present invention is to provide a method for facilitating augmented-reality-based interactions with a project model, the method being implemented by a computer system comprising one or more processor units executing computer program instructions which, when executed, perform the method. The method includes: receiving, via the image capture device, a live view of a real-world environment associated with a project model; providing an augmented reality presentation of the real-world environment, wherein the augmented reality presentation comprises the live view of the real-world environment; receiving an annotation related to an aspect in the live view of the real-world environment based on user selection of the aspect during the augmented reality presentation of the real-world environment; providing the annotation to a remote computer system to update the project model, wherein project modeling data associated with the project model is updated at the remote computer system based on the annotation; obtain, from the remote computer system, augmented reality content associated with the project model, wherein the augmented reality content obtained from the remote computer system is based on the updated project modeling data associated with the project model; and overlaying, in the augmented reality presentation, the augmented reality content on the live view of the real-world environment.

An aspect of another embodiment of the present invention is to provide a method for facilitating augmented-reality-based interactions with a project model, the method being implemented by a computer system comprising one or more processor units executing computer program instructions which, when executed, perform the method. The method includes: receiving, from a user device, an annotation for an aspect in a live view of a real-world environment associated with a project model, wherein the live view of the real-world environment is from the perspective of the user device; causing project modeling data associated with the project model to be updated based on the annotation; generating augmented reality content based on the updated project modeling data associated with the project model; and providing the augmented reality content to the user device during an augmented reality presentation of the real-world environment by the user device, wherein the augmented reality content is overlaid on the live view of the real-world environment in the augmented reality presentation.

Although the various operations are described in the above paragraphs as occurring in a certain order, the present application is not bound by the order in which the various operations occur. In alternative embodiments, the various operations may be executed in an order different from the order described above or otherwise herein.

These and other aspects of the present invention, as well as the methods of operations of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular forms of “a”, “an”, and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIG. 1A depicts a system for providing project management, in accordance with one or more embodiments of the present disclosure.

FIG. 1B depicts a user device for facilitating augmented-reality-enhanced project management, in accordance with one or more embodiments of the present disclosure.

FIGS. 2A and 2B depict representations of a two-dimensional architectural user-navigable project model, in accordance with one or more embodiments of the present disclosure.

FIGS. 3A and 3B depict user interfaces of a productivity suite, in accordance with one or more embodiments of the present disclosure.

FIGS. 3C and 3D depict a real-world environment and an augmented-reality-enhanced view of the real-world environment, in accordance with one or more embodiments of the present disclosure.

FIG. 3E depicts a computer-simulated environment of a project model, in accordance with one or more embodiments of the present disclosure.

FIG. 4 is a flowchart of a method for providing a time-based user-annotated presentation of a user-navigable project model, in accordance with one or more embodiments of the present disclosure.

FIG. 5 is a flowchart of a method for modifying an annotation provided for an object of a user-navigable project model, in accordance with one or more embodiments of the present disclosure.

FIG. 6 is flow chart of a method for facilitating augmented-reality-based interactions with a project model, in accordance with one or more embodiments.

FIG. 7 is flow chart of a method for facilitating augmented-reality-based interactions with a project model by providing, to a user device, augmented reality content generated based on a user-provided annotation for an aspect in a live view of a real-world environment, in accordance with one or more embodiments.

### DETAILED DESCRIPTION OF EMBODIMENTS OF THE INVENTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other instances, well-known structures and devices are shown in block diagram form in order to avoid unnecessarily obscuring the embodiments of the invention.

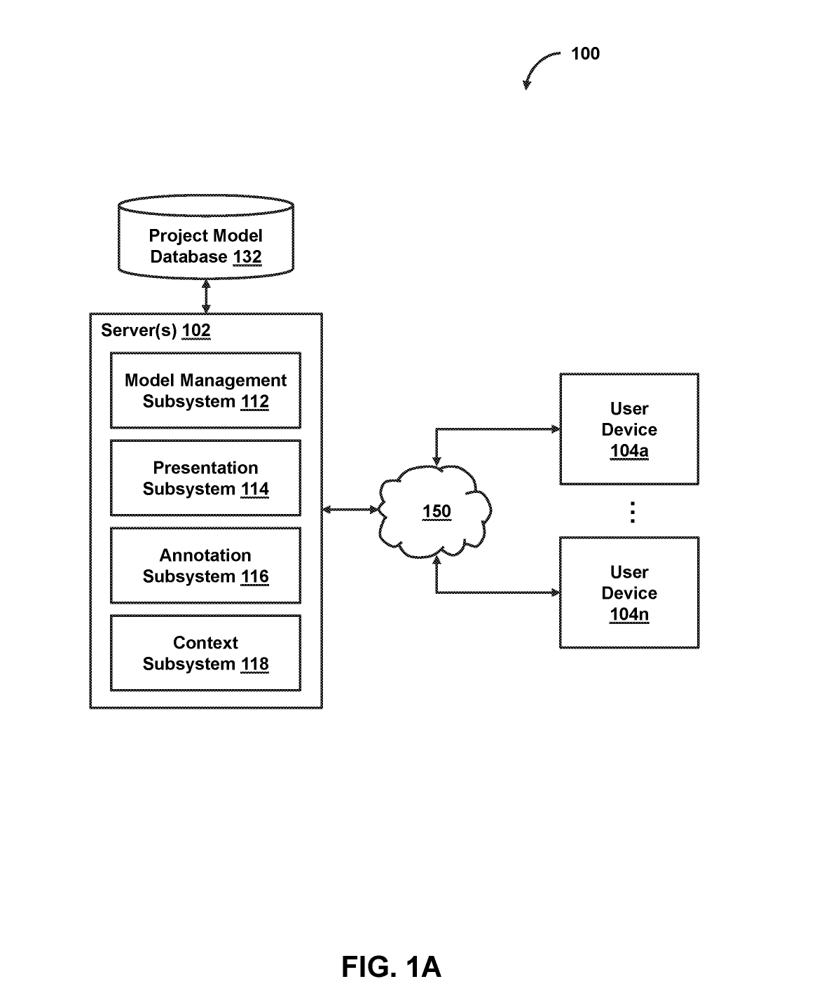

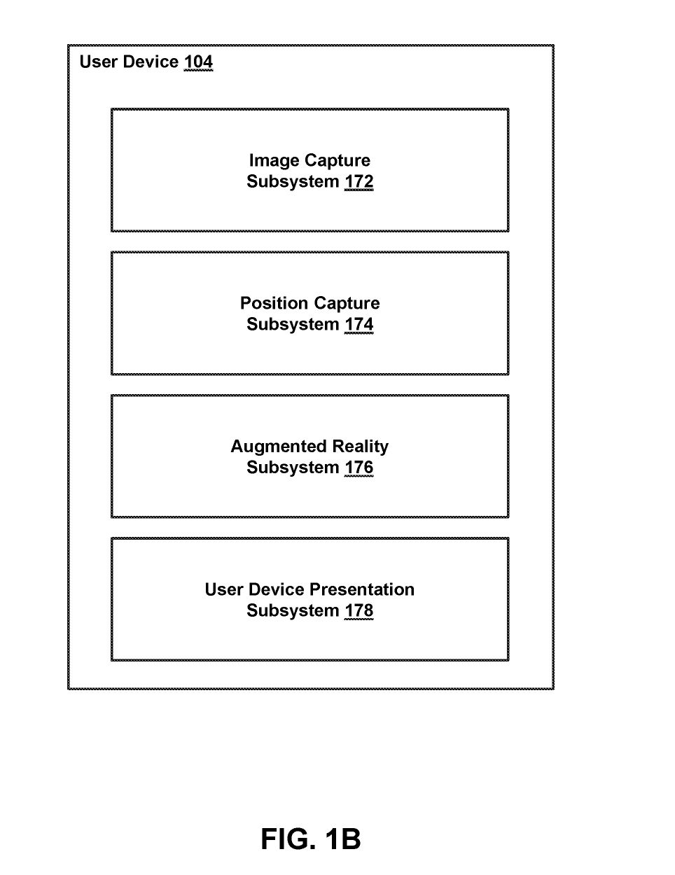

FIG. 1A depicts a system 100 for providing project management, in accordance with one or more embodiments. As shown in FIG. 1A, system 100 may comprise server 102 (or multiple servers 102). Server 102 may comprise model management subsystem 112, presentation subsystem 114, annotation subsystem 116, context subsystem 118, or other components.

System 100 may further comprise user device 104 (or multiple user devices 104a-104n). User device 104 may comprise any type of mobile terminal, fixed terminal, or other device. By way of example, user device 104 may comprise a desktop computer, a notebook computer, a tablet computer, a smartphone, a wearable device, or other user device. Users may, for instance, utilize one or more user devices 104 to interact with server 102 or other components of system 100. It should be noted that, while one or more operations are described herein as being performed by components of server 102, those operations may, in some embodiments, be performed by components of user device 104 or other components of system 100.

As shown in FIG. 1B, in an embodiment, user device 104 may comprise an image capture subsystem 172, a position capture subsystem 174, an augmented reality subsystem 176, a user device presentation subsystem 178, or other components. It should also be noted that, while one or more operations are described herein as being performed by components of user device 104, those operations may, in some embodiments, be performed by components of server 102 or other components of system 100.

Time-Based Presentation of a Project Model

In an embodiment, the model management subsystem 112 may obtain project modeling data associated with a project model (e.g., a user-navigable project model or other project model). The presentation subsystem 114 may generate a time-based presentation of the project model based on the project modeling data. The project model may comprise a building information model, a construction information model, a vehicle information model, or other project model. The project modeling data may comprise (i) data indicating one or more objects associated with the project model (e.g., model objects corresponding to real-world objects for the real-world environment), (ii) data indicating one or more user-provided annotations associated with the objects, (iii) data indicating one or more locations within the project model that objects or annotations are to be presented (or otherwise accessible to a user), (iv) data indicating one or more locations within the real-world environment that real-world objects are to be placed, (v) data indicating one or more locations within the real-world environment that annotations are to be presented (or otherwise accessible to a user), (vi) data indicating one or more times at which objects or annotations are to be presented (or otherwise accessible to a user) during a presentation of the project model, (vii) data indicating one or more times at which annotations are to be presented (or otherwise accessible to a user) during an augmented reality presentation, or (viii) other project modeling data. In an embodiment, the user may navigate the project model (e.g., two- or three-dimensional model of a house) by providing inputs via a user device 104 (e.g., a movement of a mouse, trackpad, or joystick connected to the user device 104, voice commands provided to the user device 104 for navigating through the project model, etc.), which may interpret and/or transmit the input to the server 102.

As an example, the time-based presentation of the project model may be generated such that the project model is navigable by a user via user inputs for navigating through the project model. In one use case, the time-based presentation of the project model may comprise a computer-simulated environment of the project model in which one, two, three, or more dimensions (e.g., x-axis, y-axis, z-axis, etc.) of the computer-simulated environment are navigable by the user. In another use case, the computer-simulated environment of the project model may be navigable by the user via a first-person view, a third-person view, or other view (e.g., a “god” view that enables the user to see through objects). The user may, for instance, travel through the computer-simulated environment to interact with one or more objects of the project model or other aspects of the project model. The computer-simulated environment may automatically change in accordance with the current time of the simulated environment (e.g., time references of the simulated space may be based on development stages of an associated project or based on other factors). The current time of the simulated environment may be automatically incremented or manually selected by the user.

An environment subsystem (not shown for illustrative convenience) may be configured to implement the instance of the computer-simulated environment to determine the state of the computer-simulated environment. The state may then be communicated (e.g., via streaming visual data, via object/position data, and/or other state information) from the server(s) 102 to user devices 104 for presentation to users. The state determined and transmitted to a given user device 104 may correspond to a view for a user character being controlled by a user via the given user device 104. The state determined and transmitted to a given user device 104 may correspond to a location in the computer-simulated environment. The view described by the state for the given user device 104 may correspond, for example, to the location from which the view is taken, the location the view depicts, and/or other locations, a zoom ratio, a dimensionality of objects, a point-of-view, and/or view parameters of the view. One or more of the view parameters may be selectable by the user.

The instance of the computer-simulated environment may comprise a simulated space that is accessible by users via clients (e.g., user devices 104) that present the views of the simulated space to a user (e.g., views of a simulated space within a virtual world, virtual reality views of a simulated space, or other views). The simulated space may have a topography, express ongoing real-time interaction by one or more users, and/or include one or more objects positioned within the topography that are capable of locomotion within the topography. In some instances, the topography may be a 2-dimensional topography. In other instances, the topography may be a 3-dimensional topography. The topography may include dimensions of the space, and/or surface features of a surface or objects that are “native” to the space. In some instances, the topography may describe a surface (e.g., a ground surface) that runs through at least a substantial portion of the space. In some instances, the topography may describe a volume with one or more bodies positioned therein (e.g., a simulation of gravity-deprived space with one or more celestial bodies positioned therein). The instance executed by the computer modules may be synchronous, asynchronous, and/or semi-synchronous.

The above description of the manner in which the state of the computer-simulated environment is determined by the environment subsystem is not intended to be limiting. The environment subsystem may be configured to express the computer-simulated environment in a more limited, or more rich, manner. For example, views determined for the computer-simulated environment representing the state of the instance of the environment may be selected from a limited set of graphics depicting an event in a given place within the environment. The views may include additional content (e.g., text, audio, pre-stored video content, and/or other content) that describes particulars of the current state of the place, beyond the relatively generic graphics.

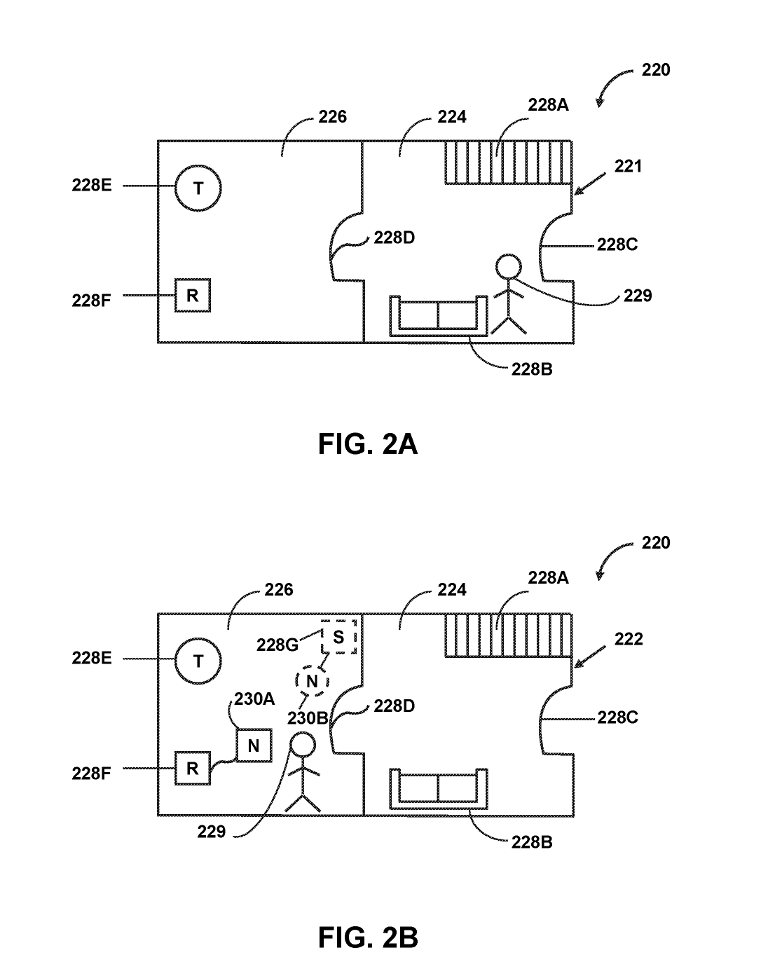

As an example, FIGS. 2A and 2B depict a schematic representation of a two-dimensional architectural user-navigable project model (or a computer-simulated environment thereof), in accordance with an embodiment of the present disclosure. Although the project model is shown in FIGS. 2A and 2B as a two-dimensional representation, the project model may also be a three-dimensional representation. In addition, FIGS. 2A and 2B are only schematic in nature and a more sophisticated rendering of the project model may be implemented to include surface rendering, texture, lighting, etc., as is known in the art. FIG. 2A depicts a first snapshot 221 of the user-navigable project model 220 taken at time T1 and FIG. 2B depicts a second snapshot 222 of the user-navigable project model 220 at a subsequent time T2 (T2>T1). For example, as shown in FIGS. 2A and 2B, the project model may be a model of a house having at least one level with two rooms 224 and 226. For example, room 224 may be a living room and room 226 may be a kitchen. For example, as shown in FIG. 2A, at time T1, room 224 may comprise stairs 228A, a sofa 228B, an entrance or doorway 228C, and entrance or doorway 228D (that is shared with room 226). At time T2, room 226 may comprise a table (T) 228E and refrigerator (R) 228F. A user represented by, for example, avatar 229 may navigate the user-navigable project model 220. As shown in FIGS. 2A and 2B, at the snapshot 221 at time T1, the avatar 229 is shown in room 224 and, at the snapshot 222 at time T2, the avatar 229 is shown in room 226. The user may navigate the user-navigable project model 220 by transmitting inputs, requests or commands via a user device 104. Although the user is represented in FIGS. 2A and 2B by an avatar, it should be noted that, in one or more embodiments, a user navigating a project model may not necessarily be represented by an avatar. In some embodiments, navigation of the navigable project model is not limited to any particular fixed field-of-view. As an example, the presentation of the navigable project model may allow for a full 360° panorama view or other views.

In an embodiment, annotation subsystem 116 may receive an annotation for an object within a project model (e.g., a user-navigable project model or other project model). As an example, the annotation for the object may be received based on user selection of the object during a time-based presentation of the project model. Based on the receipt of the annotation, presentation subsystem 114 may cause the annotation to be presented with the object during at least another presentation of the project model (e.g., another time-based presentation or other presentation of the project model). As used herein, “annotations” may comprise reviews, comments, ratings, markups, posts, links to media or other content, location reference (e.g., location of an object within a model, location of real-world object represented by the object, etc.), time references (e.g., creation time, modification time, presentation time, etc.), images, videos, or other annotations. Annotations may be manually entered by a user for an object or other aspects of a project model, or automatically determined for the object (or other aspects of the project model) based on interactions of the user with the object, interactions of the user with other objects, interactions of the user with other project models, or other parameters. Annotations may be manually entered or automatically determined for the object or aspects of the project model before, during, or after a presentation of the object or the project model (e.g., a time-based presentation thereof, an augmented reality presentation that augments a live view of a real-world environment associated with the project model, or other presentation). Annotations may be stored as data or metadata, for example, in association with the object, the project model, or information indicative of the object or the project model.

In one use case, a user may use user device 104 to provide an image, a video, or other content (e.g., in the form of an annotation) for an object or other aspect of a project model. For example, to help illustrate an evacuation route of a house, the user may provide an animation (e.g., 2D animation, 3D animation, etc.) to one or more hallways, stairs, or doorways of the house model, where the animation may lead the user (or other users navigating the house model) through the evacuation route. As such, when one or more other users (e.g., a potential resident of the house, a head of staff for the potential resident, a manager of the construction of the house, an inspector of the home, etc.) are accessing a presentation of the project model, they may be presented with the animation that guides them through the evacuation route.

In another use case, with respect to FIGS. 2A and 2B, when a user is navigating through the user-navigable project model 220 (or a computer-simulated environment thereof) as shown in FIGS. 2A and 2B, the user (represented by avatar 229) may be able to provide an annotation 230A for the refrigerator 228F. As a result of the user providing the annotation 230A for the refrigerator 228F, the annotation 230A may be associated with the refrigerator 228F. As another example, if the user provides the annotation 230A as an annotation for one or more other selected objects (e.g., objects 228 or other objects), the annotation 230A may be associated with the selected object(s). In a further use case, when the user or another user is navigating through the user-navigable project model 220 during one or more subsequent presentations of the user-navigable project model 220, the annotation 230A may be presented with the selected object (e.g., if the annotation 230A is provided for the refrigerator 228F, it may be presented with the refrigerator 228F during the subsequent presentations).

In an embodiment, the context subsystem 118 may associate an annotation with one or more objects, location references, time references, or other data. In an embodiment, for example, context subsystem 118 may reference an annotation to one or more coordinates (or other location references) with respect to a project model. Based on the referenced coordinates, the presentation subsystem 114 may cause the annotation to be presented at a location within the project model that corresponds to the referenced coordinates during a presentation of the project model. As an example, upon receipt of an annotation during a time-based presentation of a user-navigable project model, the context subsystem 118 may assign particular coordinates to the received annotation, where the assigned coordinates may correspond to a location of an object (e.g., for which the annotation is provided) within the user-navigable project model. The assigned coordinates may be stored in association with the annotation such that, during a subsequent presentation of the user-navigable project model, the annotation is presented at the corresponding location based on the association of the assigned coordinates. The assigned coordinates may, for instance, comprise coordinates for one or more dimensions (e.g., two-dimensional coordinates, three-dimensional coordinates, etc.). In one use case, with respect to FIG. 2B, the annotation 230A may be presented at a location corresponding to coordinates within the user-navigable project model 220 during a presentation of the user-navigable project model based on the coordinates being assigned to the annotation 230A. If, for instance, the corresponding location is the same location as or proximate to the location of an associated object (e.g., an object for which the annotation 230A is provided), the annotation 230A may be presented with the object during the presentation of the user-navigable project model. In another use case, this presentation of the annotation 230A may occur automatically, but may also be “turned off” by a user (e.g., by manually hiding the annotation 230A after it is presented, by setting preferences to prevent the annotation 230A from being automatically presented, etc.). As an example, the user may choose to reduce the amount of automatically-displayed annotations or other information via user preferences (e.g., by selecting the type of information the user desires to be automatically presented, by selecting the threshold amount of information that is to be presented at a given time, etc.).

In an embodiment, the context subsystem 118 may reference an annotation to a time reference. Based on the time reference, the presentation subsystem 114 may cause the annotation to be presented at a time corresponding to the time reference during a presentation of the project model. The time reference may comprise a time reference corresponding to a time related to receipt of the annotation during a presentation of a project model, a time reference selected by a user, or other time reference. As an example, upon receipt of an annotation during a time-based presentation of a user-navigable project model, the context subsystem 118 may assign a time reference to the annotation, where the time reference is the same as the time reference of the presentation of the user-navigable project model at which a user (interacting with the presentation of the project model) provides the annotation.

In one scenario, with respect to FIG. 2B, if a user provides the annotation 230A for refrigerator 228F at the time reference “May 2016” of a presentation of a user-navigable project model, the “May 2016” time reference may be assigned to the annotation 230A. As a result, for example, after the time reference is assigned, the annotation 230A may be presented during a subsequent presentation of the user-navigable project model when the current time reference of the subsequent presentation reaches the “May 2016” time reference. The annotation 230A may then continue to be presented (or at least available for presentation) for a predefined duration (e.g., a fixed duration, a remaining duration of the presentation, etc.). The predefined duration may, for instance, be a default duration, a duration defined based on a preference of a user interacting with the presentation, a duration defined by the interacting user for the annotation 230A, or other duration.

In an embodiment, the context subsystem 118 may associate an annotation with data relevant to an object of a project model (e.g., a user-navigable project model or other project model). Based on such association, the annotation subsystem 116 may modify the annotation based on the relevant data. As an example, data relevant to the object may be identified based on information in the annotation (e.g., one or more references to products or services related to the object, one or more words, phrases, links, or other content related to the object, etc.), other annotations associated with the object (e.g., an annotation identifying a user that added or modified the object, an annotation identifying a time that the object was added or modified, an annotation identifying a location of the object within the project model or relative to other objects of the user-navigable project model, etc.), or other information related to the object.

In an embodiment, the annotation subsystem 116 may add or modify an annotation associated with an object of a project model such that the annotation includes a mechanism to access one or more images, videos, or other content relevant to the object. As an example, the context subsystem 118 may interact with one or more social media platforms to identify an image, video, or other content relevant to the object. In one use case, the context subsystem 118 may provide a query to a social media platform external to server 102 (or other computer system hosting the context subsystem 118), such as PINTEREST or other social media platform, to identify the image, video, or other content to be included in the annotation. The query may be based on the type of object (e.g., refrigerator, sofa, stairs, television, or other object type), a location associated with the object (e.g., a living room, a master bedroom, a guest bedroom, an office, a kitchen, or other associated location), or other attributes of the object (or other information to identify data relevant to the object). The query may alternatively or additionally be based on user profile information of a user (e.g., a future user of the object such as a home owner or other future user, a user that provided the object for the project model, a user that provided the annotation, or other user). The user profile information (on which the query may be based) may comprise interior decorators preferred by the user, accounts preferred by the user (e.g., the user's favorite social media celebrities), brands preferred by the user, cost range preferred by the user, age of the user, gender of the user, ethnicity or race of the user, or other user profile information.

In a further use case, for instance, where the context subsystem 118 is identifying content relevant to a sofa located in a bedroom, a query for PINTEREST may be generated to identify images or videos showing a variety of sofas in settings decorated for a bedroom. Upon identification, the annotation subsystem 116 may add or modify an annotation for the sofa to include one or more hyperlinks to a PINTEREST page depicting one or more of the images or videos, embedded code that causes one or more of the images or videos to be presented upon presentation of the annotation, or other mechanism to access the content.

As another example, the context subsystem 118 may process an annotation for an object of a project model to identify, in the annotation, a reference to a product or service related to the object. In one scenario, with respect to FIG. 2B, when a user provides the annotation 230A for the refrigerator 228F, the user may describe a particular refrigerator that the user desires (e.g., the brand and model of the refrigerator). Upon receipt of the annotation, the context subsystem 118 may process the annotation 230A and identify the particular refrigerator. The annotation subsystem may modify the annotation 230A based on such identification. Additionally, or alternatively, the annotation may comprise other descriptions, such as capacity, size, color, or other attributes, on which identification of the particular refrigerator may be based. As a further example, the context subsystem 118 may modify the annotation to include a mechanism to enable a transaction for a product or service. With respect to FIG. 2B, for instance, upon identification of a particular refrigerator based on a description in the annotation 230A, the annotation subsystem may modify the annotation to include a hyperlink to a merchant web page offering the particular refrigerator for sale, embedded code for a “buy” button or a shopping cart for purchasing the particular refrigerator, or other mechanism that enables a transaction for the particular refrigerator.

In an embodiment, model management subsystem 112 may receive a request to add, modify, or remove one or more objects of a project model (e.g., a user-navigable project model or other project model). As an example, the object-related requests may be received based on user selection of the object during a time-based presentation of the project model. As another example, the object-related requests may be received based on user selection of the objects before or after the time-based presentation of the project model. The requests may be manually entered by a user for the objects, or automatically generated for the objects based on interactions of the user with the project model, interactions of the user with other project models, or other parameters. Upon receipt of a request to add, modify, or remove an object, the project model may be updated to reflect the object request by adding, modifying, or removing the object within the project model.

In one use case, with respect to FIG. 2B, if a user inputs commands to add a stove (S) 228G in room 226 during a presentation of the user-navigable project model 220, the user-navigable project model 220 may be updated to include the stove 228G such that the stove 228G is caused to be presented in the current presentation or a subsequent presentation of the project model 220 (e.g., to the user or another user). Additionally, or alternatively, if a user inputs commands to remove the refrigerator 228F during a presentation of the user-navigable project model 220, the user-navigable project model 220 may be updated to reflect the removal such that the refrigerator 228F may not be presented in the current presentation or a subsequent presentation of the project model 220.

In an embodiment, the context subsystem 118 may associate one or more objects of a project model with one or more location references, time references, or other data. In an embodiment, for example, context subsystem 118 may reference an object to one or more coordinates (or other location references) with respect to a project model. Based on the referenced coordinates, the presentation subsystem 114 may cause the object to be presented at a location within the project model that corresponds to the referenced coordinates during a presentation of the project model. As an example, upon receipt of a request to add an object during a time-based presentation of a user-navigable project model, the context subsystem 118 may assign particular coordinates to the object, where the assigned coordinates may correspond to a location of a user within the user-navigable project model at the time that the user provided the request to add the object. The assigned coordinates may be stored in association with the object such that, during a subsequent presentation of the user-navigable project model, the object is presented at the corresponding location based on the association of the assigned coordinates. The assigned coordinates may, for instance, comprise coordinates for one or more dimensions (e.g., two-dimensional coordinates, three-dimensional coordinates, etc.). In one use case, with respect to FIG. 2B, the objects 228 may be presented at respective locations corresponding to coordinates within the user-navigable project model 220 during a presentation of the user-navigable project model based on the coordinates being assigned to the objects 228, respectively.

In an embodiment, the context subsystem 118 may reference an object of a project model to a time reference. Based on the time reference, the presentation subsystem 114 may cause the object to be presented at a time corresponding to the time reference during a presentation of the project model. The time reference may comprise a time reference corresponding to a time related to receipt of a request to add an object during a presentation of a project model, a time reference selected by a user, or other time reference. As an example, upon receipt of a request to add an object during a time-based presentation of a user-navigable project model, the context subsystem 118 may assign a time reference to the object, where the time reference is the same as the time reference of the presentation of the user-navigable project model at which a user (interacting with the presentation of the project model) provides the request to add the object to the user-navigable project model.

In one scenario, with respect to FIG. 2B, if a user provides a request to add the stove 228G at the time reference “June 2016” of a presentation of a user-navigable project model, the “June 2016” time reference may be assigned to the stove 228G. As a result, for example, after the time reference is assigned, the stove 228G may be presented during a subsequent presentation of the user-navigable project model when the current time reference of the subsequent presentation reaches the “June 2016” time reference. The stove 228G may then continue to be presented (or at least available for presentation) for a predefined duration (e.g., a fixed duration, a remaining duration of the presentation, etc.). The predefined duration may, for instance, be a default duration, a duration defined based on a preference of a user interacting with the presentation, a duration defined by the interacting user for an object (e.g., the stove 228G), or other duration.

Productivity Suite

In an embodiment, the context subsystem 118 may cause an addition, modification, or removal of one or more objects of a project model, annotations, action items, events (e.g., electronic appointment, meeting invitation, etc., with times, locations, attachments, attendees, etc.), conversations, documents, or other items based on one or more context sources. These operations may, for example, be automatically initiated based on the context sources. The context sources may comprise one or more other objects, annotations, actions items, events, conversations, documents, or other context sources.

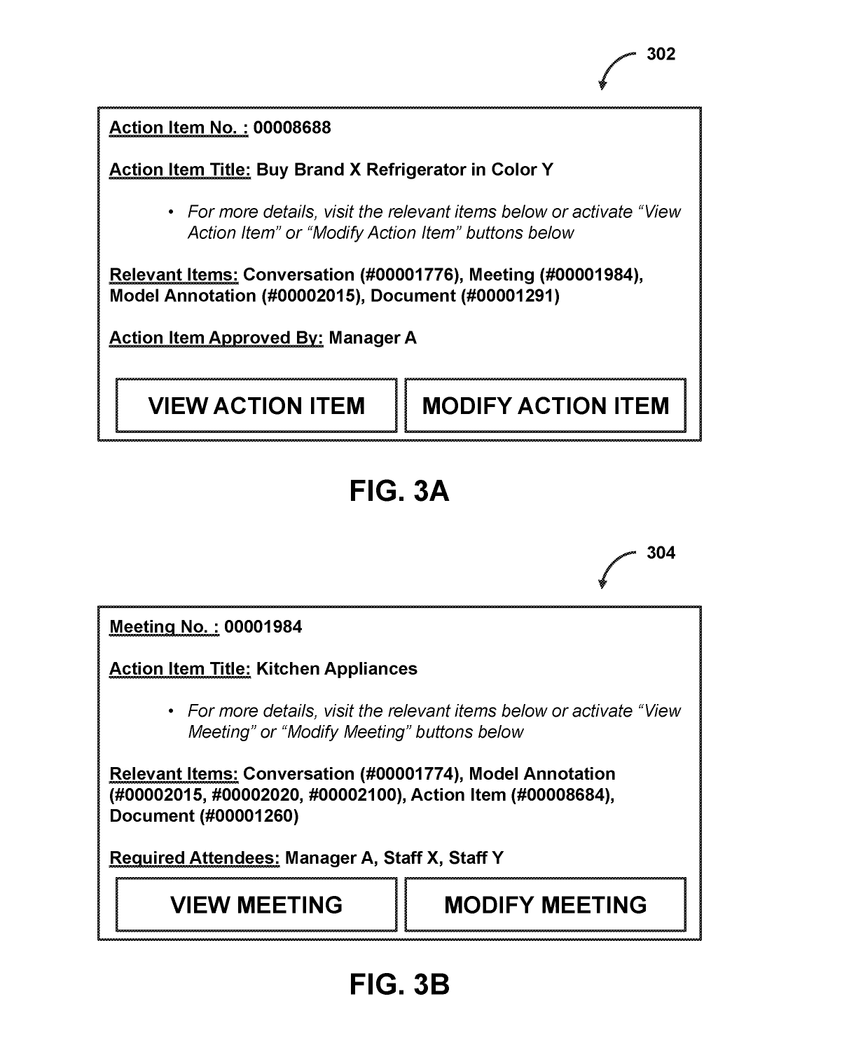

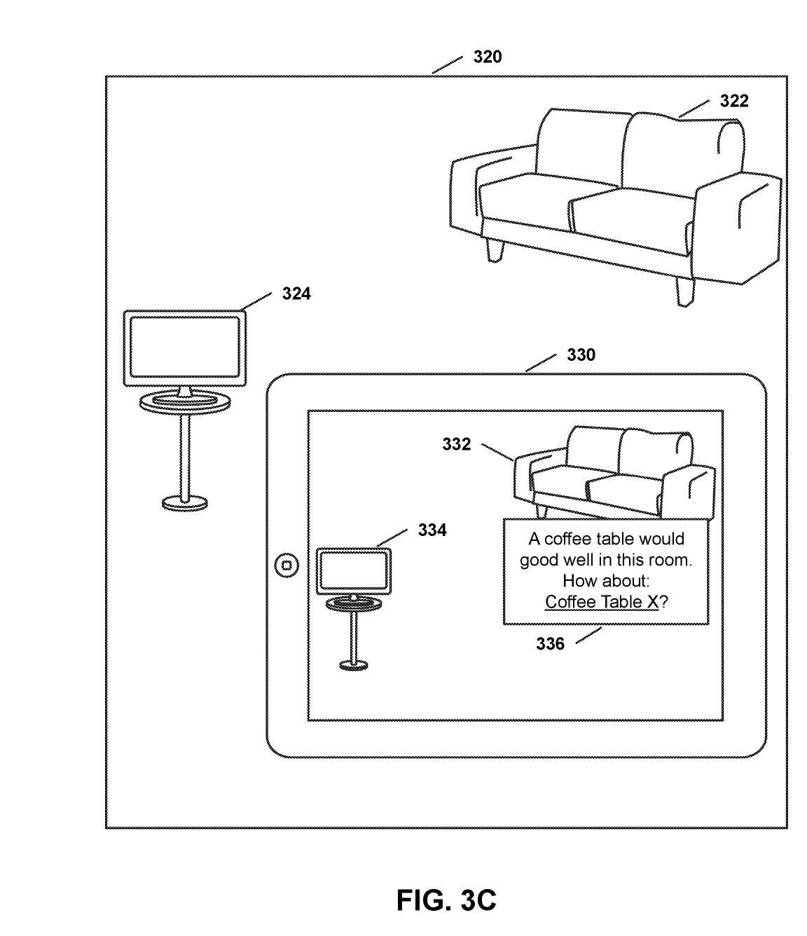

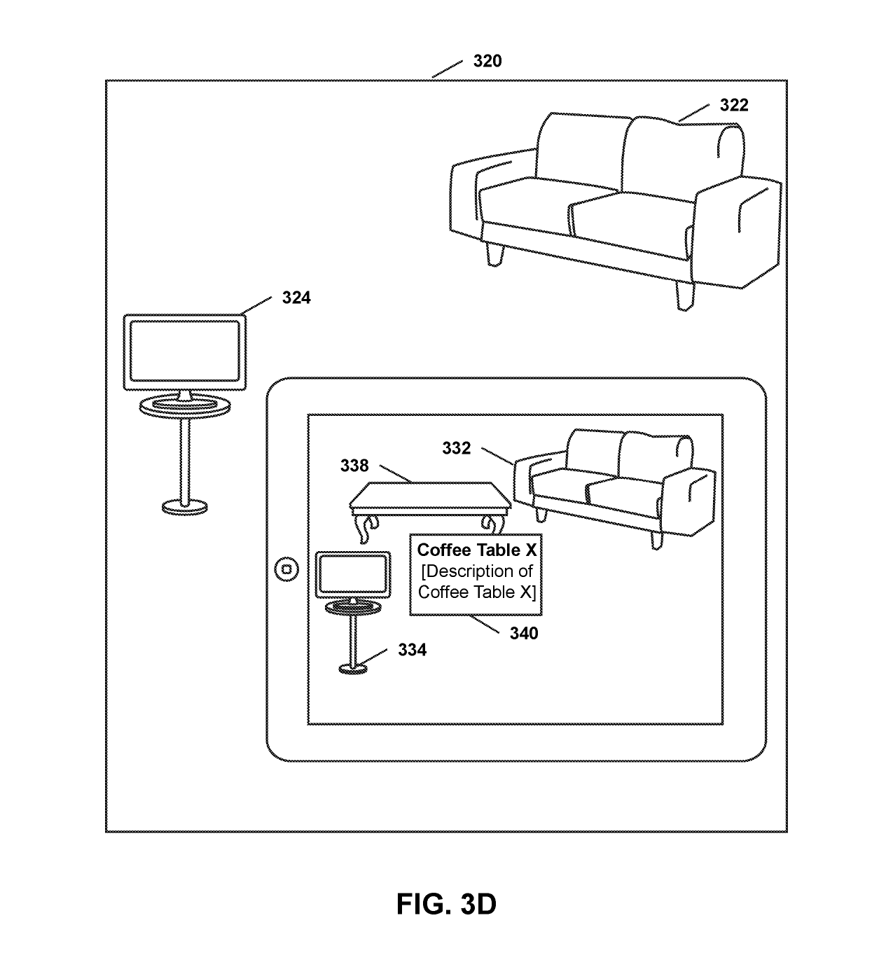

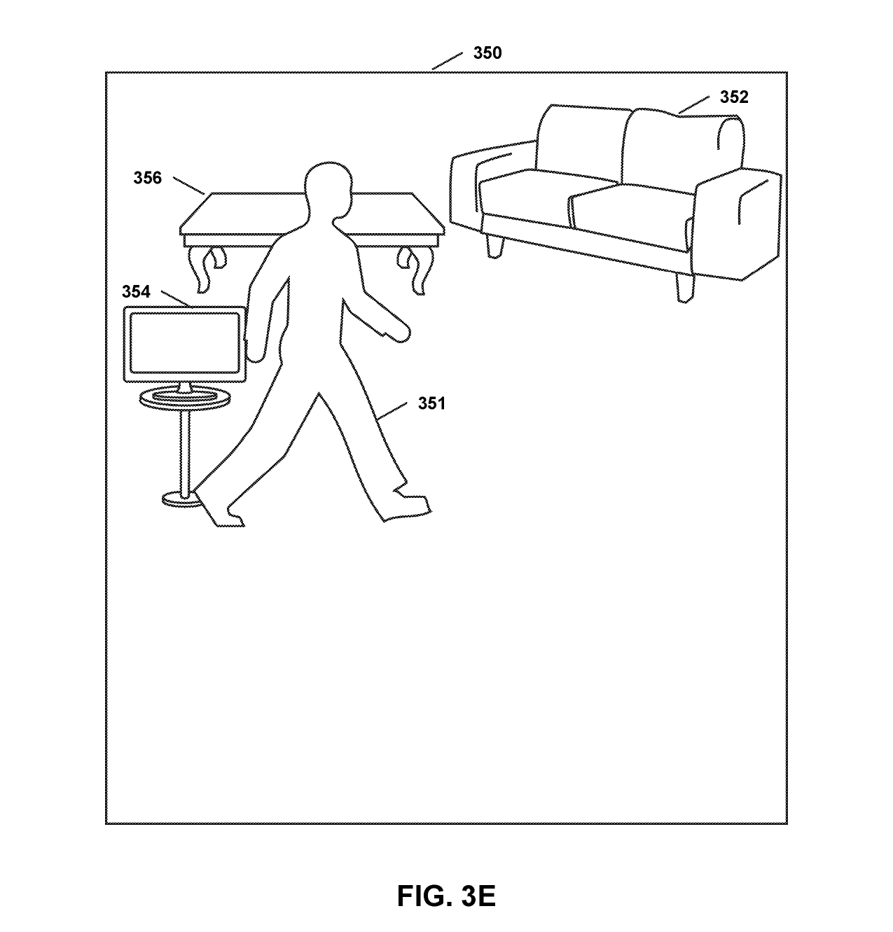

As an example, one or more action items may be generated and added to a project based on one or more events, conversations, documents, other action items, or other items associated with the project (or those associated with other projects). Additionally, or alternatively, the action items may be modified or removed from the project based on one or more events, conversations, documents, other action items, or other items associated with the project (or those associated with other projects). In one use case, with respect to FIG. 3A, user interface 302 may show an action item (e.g., action item no. 00008688) that may have been generated based on a conversation and a meeting (e.g., conversation no. 00001776 and meeting no. 00001984). For example, one or more fields of the meeting (e.g., a calendar invite for the meeting) may list one or more agenda items for discussion, such as which refrigerator is to be added to a kitchen of a remodeled home. During the conversation, an indication that a particular brand and color is to be purchased for the kitchen of the remodeled home may occur. The conversation (e.g., a text chat, a video chat, a teleconference call, etc.) may be recorded, and the conversation recording may be stored. If the conversation is already associated in a database with the meeting, the context subsystem 118 may detect that the conversation and the meeting are related based on the stored record of the association, the relatedness between the agenda items of the meeting and the discussion during the conversation (e.g., both specify refrigerators), or other criteria (e.g., time of the meeting and time of the conversation). If, for instance, the conversation and the meeting are not already associated with one another, the context subsystem 118 may detect that they are related to one another based on a predefined time of the meeting and a time that the conversation occurred, and/or based on one or more other criteria, such as the relatedness between the agenda items and the discussion during the conversation or other criteria.

Upon detecting that the meeting and the conversation are related (and/or determining that their relatedness satisfies a predefined relatedness threshold), the context subsystem 118 may utilize the contents of the meeting and the conversation to generate the action item and associate the action item with the project. In one scenario, context subsystem 118 may perform natural language processing on the contents of the meeting and the conversation to generate the action item. For instance, if a manager approves the purchasing of a refrigerator of a particular brand and color during the conversation (e.g., “Manager A” listed on the user interface 302), this approval may be detected during processing of the contents of the conversation, and cause the action item to “Buy Brand X Refrigerator in Color Y” to be generated and added to the project.

As another example, one or more action items may be generated and added to a project based on one or more objects of a project model, annotations provided for the object, or other items. Additionally, or alternatively, the action items may be modified or removed based on one or more objects of a project model, annotations provided for the object, or other items. In one use case, with respect to FIG. 3A, user interface 302 may show an action item (e.g., action item no. 00008688) that may have been generated based on an object (e.g., a refrigerator) of a project model and an annotation (e.g., annotation no. 00002015) provided for the object. For example, if the object is a refrigerator, and the annotation has the text “Buy Brand X in Color Y,” the context subsystem 118 may perform natural language processing on the object and the annotation to detect the action “Buy” and the parameters “refrigerator,” “Brand X,” and “Color Y,” and generate the action item based on the detected action and parameters.

As yet another example, one or more events may be initiated and added to a project based on one or more action items, conversations, documents, other events, or other items associated with the project (or those associated with other projects). Additionally, or alternatively, the events may be modified or removed from the project based on one or more action items, conversations, documents, other events, or other items associated with the project (or those associated with other projects). In one use case, with respect to FIG. 3B, user interface 304 may show a meeting (e.g., meeting no. 00001984) that may have been generated based on a conversation (e.g., conversation no. 00001774) and an action item (e.g., action item no. 00008684). For example, the action item may be created by a user to specify that a meeting to discuss kitchen appliances for a kitchen of a remodeled home should take place. If the conversation subsequently takes place and includes discussions regarding the required or optional attendees for such a meeting, the context subsystem 118 may generate a calendar invite for the meeting and add the meeting to the project based on the conversation. The generated calendar invite may, for instance, include the required or optional attendees based on the context subsystem 118 detecting such discussion during the conversation, as well as the title field or other fields based on the context subsystem 118 processing the fields of the action item previously created by the user.

As another example, one or more events may be generated and added to a project based on one or more objects of a project model, annotations provided for the object, or other items. Additionally, or alternatively, the action items may be modified or removed based on one or more objects of a project model, annotations provided for the object, or other items. In one use case, with respect to FIG. 3B, user interface 304 may show a meeting (e.g., meeting no. 00001984) that may have been generated based on an object (e.g., a refrigerator) of a project model and an annotation (e.g., annotation no. 00002015, annotation no. 00002020, annotation no. 00002100, etc.) provided for the object. For example, if the object is a refrigerator, and the annotation has the text “what kind of refrigerator should this be?,” the context subsystem 118 may perform natural language processing on the object and the annotation to detect the need for a meeting to discuss the refrigerator or other kitchen appliances,” and generate a calendar invite for the meeting based thereon.

As yet another example, one or more objects or annotations may be generated and added to a project model based on one or more action items, events, conversations, documents, or other items associated with a project (e.g., a project associated with the project model). Additionally, or alternatively, the objects or annotations may be modified or removed from the project model based on one or more action items, events, conversations, documents, or other items associated with a project (e.g., a project associated with the project model). In one scenario, context subsystem 118 may perform natural language processing on the contents of one or more of the foregoing context sources, and add an object or annotation to the project model based thereon (or modify or remove the object or annotation from the project model based thereon). For instance, if a manager approves the purchasing of a refrigerator of a particular brand and color during a conversation, this approval may be detected during processing of the contents of the conversation, and cause a refrigerator to be added to the project model along with an annotation describing the brand and color of the refrigerator.

As another example, one or more objects or annotations may be generated and added to a project model based on one or more other objects of the project model, annotations provided for the other objects, or other items. Additionally, or alternatively, the objects or annotations may be modified or removed from the project model based on one or more other objects of the project model, annotations provided for the other objects, or other items.

Augmented-Reality-Based Interactions

In an embodiment, an augmented reality presentation of a real-world environment may be provided to facilitate one or more projects, including projects involving or related to construction, improvements, maintenance, decoration, engineering, security, management, or other projects related to the real-world environment. In an embodiment, as described herein, the augmented reality presentation of the real-world environment may be provided to facilitate creation and updating of a project model associated with the real-world environment, where the project model (or associated project modeling data thereof) may be created or updated based on interactions effectuated via the augmented reality presentation. The augmented reality presentation may, for example, comprise a live view of the real-world environment and one or more augmentations to the live view. The augmentations may comprise content derived from the project modeling data associated with the project model, other content related to one or more aspects in the live view, or other augmentations. In an embodiment, the project model (or its associated project modeling data) may be utilized to generate a time-based presentation of the project model such that the project model is navigable by a user via user inputs for navigating through the project model.

In an embodiment, as described herein, the augmented reality presentation of the real-world environment may be provided to facilitate addition, modification, or removal of one or more action items, events, conversations, documents, or other items for a project. In an embodiment, the addition, modification, or removal of the foregoing items may be automatically initiated based on one or more context sources (e.g., one or more other objects, annotations, actions items, events, conversations, documents, or other context sources), including context sources created or updated via the augmented reality presentation and user interactions thereof.

In an embodiment, the user device 104 may comprise an augmented reality application stored on the user device 104 configured to perform one or more operations of one or more of the image capture subsystem 172, the position capture subsystem 174, the augmented reality subsystem 176, the user device presentation subsystem 178, or other components of the user device 104, as described herein.

In an embodiment, the image capture subsystem 172 may receive, via an image capture device of the user device 104, a live view of a real-world environment associated with a project model (e.g., building information model, a construction information model, a vehicle information model, or other project model). The user device presentation subsystem 178 may provide an augmented reality presentation of the real-world environment that comprises the live view of the real-world environment. The augmented reality subsystem 176 may receive an annotation related to an aspect in the live view of the real-world environment. As an example, the annotation may be received based on user selection of the aspect during the augmented reality presentation of the real-world environment. In one use case, the real-world environment may be a residence or a section thereof (e.g., main house, guest house, recreational area, first floor, other floor, master bedroom, guest bedroom, family room, living room, kitchen, restroom, foyer, garage, driveway, front yard, backyard, or other section). In another use case, the real-world environment may be a business campus or a section thereof (e.g., office building, recreational area, parking lot, office building floor, office, guest area, kitchen, cafeteria, restroom, or other section). In yet another use case, the real-world environment may be a vehicle (e.g., plane, yacht, recreational vehicle (RV), or other vehicle) or a section thereof.

In an embodiment, upon receipt of an annotation (e.g., during an augmented reality presentation of a real-world environment), the augmented reality subsystem 176 may provide the annotation to a remote computer system. As an example, the annotation may be provided to the remote computer system to update a project model, where project modeling data associated with the project model may be updated at the remote computer system based on the annotation. The project model may, for instance, be associated with the real-world environment, where its project modeling data corresponds to one or more aspects of the real-world environment. In this way, for example, the system 100 enables a user (e.g., owner or manager of a business or residence, engineer, designer, or other user) to experience a project in the physical, real-world environment through an augmented reality presentation that augments the real-world environment with aspects of the project and that enables the user to interact with and update an associated project model (e.g., useable by the user or others to view and interact with the project).

The project modeling data may comprise (i) data indicating one or more objects associated with the project model (e.g., model objects corresponding to real-world objects for the real-world environment), (ii) data indicating one or more user-provided annotations associated with the objects, (iii) data indicating one or more locations within the project model that objects or annotations are to be presented (or otherwise accessible to a user), (iv) data indicating one or more locations within the real-world environment that real-world objects are to be placed, (v) data indicating one or more locations within the real-world environment that annotations are to be presented (or otherwise accessible to a user), (vi) data indicating one or more times at which objects or annotations are to be presented (or otherwise accessible to a user) during a presentation of the project model, (vii) data indicating one or more times at which annotations are to be presented (or otherwise accessible to a user) during an augmented reality presentation, or (viii) other project modeling data.

In one scenario, with respect to FIG. 3C, a user in a real-world environment 320 (e.g., a living room with a sofa 322, a television 324, or other real-world objects) may utilize a user device 330 (e.g., a tablet or other user device) to access an augmented reality presentation of the real-world environment 320. As shown in FIG. 3C, for example, an augmented reality application on the user device 330 may provide a user interface comprising the augmented reality presentation, where the augmented reality presentation depicts a live view of the real-world environment 320 (e.g., where aspects 332 and 334 of the live view corresponds to the real-world sofa 322 and television 324).

In a further scenario, with respect to FIG. 3C, the user may interact with one or more aspects in the augmented reality presentation (e.g., clicking, tapping, or otherwise interacting with aspects 332 and 334 or other aspects in the augmented reality presentation) to provide one or more annotations for the aspects in the augmented reality presentation. As an example, the user may tap on the sofa-related aspect 332 to provide an annotation for the aspect 332 (or the sofa 322). Upon providing the annotation, for instance, the augmented reality application may transmit the annotation to a remote computer system hosting a computer-simulated environment that corresponds to the real-world environment 320. Upon obtaining the annotation, the remote computer system may utilize the annotation to update a project model associated with the real-world environment 320 (e.g., by adding the annotation to the project model and associating the annotation with an object of the project model that corresponds to the sofa 322). In yet another scenario, when the computer-simulated environment (corresponding to the real-world environment 320) is subsequently accessed, the computer-simulated environment may display the annotation in conjunction with the object representing the sofa 322 based on the updated project model.

In an embodiment, the augmented reality subsystem 176 may obtain augmented reality content associated with a project model, and provide the augmented reality content for presentation during an augmented reality presentation of a real-world environment (e.g., associated with the project model). As an example, the augmented reality content may comprise visual or audio content (e.g., text, images, audio, video, etc.) generated at a remote computer system based on project modeling data associated with the project model, and the augmented reality subsystem 176 may obtain the augmented reality content from the remote computer system. In an embodiment, the augmented reality subsystem 176 may overlay, in the augmented reality presentation, the augmented reality content on a live view of the real-world environment. In an embodiment, the presentation of the augmented reality content (or portions thereof) may occur automatically, but may also be “turned off” a the user (e.g., by manually hiding the augmented reality content or portions thereof after it is presented, by setting preferences to prevent the augmented reality content or portions thereof from being automatically presented, etc.). As an example, the user may choose to reduce the amount of automatically-displayed content via user preferences (e.g., by selecting the type of information the user desires to be automatically presented, by selecting the threshold amount of information that is to be presented at a given time, etc.).

In an embodiment, the position capture subsystem 174 may obtain position information indicating a position of a user device (e.g., the user device 104), and the user device presentation subsystem 178 (and/or the augmented reality subsystem 176) may provide an augmented reality presentation of a real-world environment based on the position information. The position information may comprise location information indicating a location of the user device, orientation information indicating an orientation of the user device, or other information.

As an example, the augmented reality subsystem 176 may obtain augmented reality content prior to or during an augmented reality presentation of a real-world environment based on the position information (indicating the position of the user device). In one use case, the augmented reality subsystem 176 may provide the location information (indicating the user device's location) to a remote computer system (e.g., the server 102) along with a request for augmented reality content relevant to the user device's location. In response, the remote computer system may process the location information and the content request. If, for instance, the remote computer system determines (e.g., based on the location information) that a user of the user device is in the particular real-world environment (e.g., a site of a residence being constructed or modified, a site of a business campus being constructed or modified, etc.), the remote computer system may return augmented reality content associated with the real-world environment for the augmented reality presentation of the real-world environment. Additionally, or alternatively, if the remote computer system determines that a user of the user device (outside of the real-world environment) is in proximity of the real-world environment, the remote computer system may also return augmented reality content associated with the real-world environment. In this way, for example, the augmented reality content for an augmented reality presentation of the real-world environment may already be stored at the user device by the time the user is at the real-world environment for faster access by the augmented reality subsystem 176 of the user device during the augmented reality presentation of the real-world environment.

As another example, the user device presentation subsystem 178 may present augmented reality content in an augmented reality presentation based on the position information (indicating the position of the user device). In one scenario, different content may be presented over a live view of the real-world environment depending on where the user device is located (and, thus, likely where the user is located) with respect to the real-world environment, how the user device is oriented (and, thus, likely where the user is looking), or other criteria. For example, augmented reality content associated with a location, a real-world object, or other aspect of the real-world environment may be hidden if the user device is too far from the location, real-world object, or other aspect of the real-world environment (e.g., outside a predefined proximity threshold of the aspect of the real-world environment), but may be displayed once the user device is detected within a predefined proximity threshold of the aspect of the real-world environment. Additionally, or alternatively, the augmented reality content may be hidden if the user device is oriented in a certain way, but may be displayed once the user device is detected to be in an acceptable orientation for presentation of the augmented reality content. In another scenario, different sizes, colors, shadings, orientations, locations, or other attribute of augmented reality content (with respect to an augmented reality presentation) may be presented over a live view of the real-world environment depending on the distance of the user device from a location, real-world object, or other aspect of the real-world environment, the orientation of the aspect of the real-world environment, or other criteria.

In an embodiment, the augmented reality subsystem 176 may obtain augmented reality content (for an augmented reality presentation of a real-world environment) comprising an annotation that was provided by a user (e.g., via an augmented reality interaction, via a computer-simulated environment interaction, etc.). As an example, the annotation may be utilized to update project modeling data associated with a project model (e.g., by associating the annotation with one or more objects or other aspects of the project model). The annotation may be extracted from the updated project modeling data to generate augmented reality content associated with the project model or the real-world environment such that the generated content comprises the extracted annotation. Upon obtaining the generated content, the augmented reality subsystem 176 may overlay the annotation on a live view of the real-world environment in the augmented reality presentation.

In an embodiment, the augmented reality subsystem 176 may obtain augmented reality content (for an augmented reality presentation of a real-world environment) comprising content derived from an annotation that was provided by a user (e.g., via an augmented reality interaction, via a computer-simulated environment interaction, etc.). As an example, where the annotation was provided for an aspect in a live view of the real-world environment (e.g., during the augmented reality presentation, during a prior augmented reality presentation, etc.), the derived content may comprise (i) a mechanism to access an image or video related to the aspect in the live view of the real-world environment, (ii) a mechanism to enable a transaction for a product or service related to the annotation, (iii) a mechanism to access an action item, event, conversation, or document related to the annotation, or (iv) other content. Upon obtainment, the augmented reality subsystem 176 may overlay the derived content on a live view of the real-world environment in the augmented reality presentation.

In an embodiment, the annotation subsystem 116 may receive, from a user device, an annotation for an aspect in a live view of a real-world environment. As an example, the live view of the real-world may comprise a view from the perspective of the user device obtained by the user device via an image capture device of the user device. In an embodiment, the model management subsystem 112 may cause project modeling data associated with a project model to be updated based on the annotation. As an example, the project model may be associated with the real-world environment. In one use case, for example, the project model may comprise project modeling data corresponding to one or more aspects of the real-world environment. The project model may comprise a building information model, a construction information model, a vehicle information model, or other project model.

In an embodiment, the context subsystem 118 may generate augmented reality content based on project modeling data associated with a project model. In an embodiment, where project modeling data is updated based on an annotation (e.g., for an aspect in a live view of a real-world environment), the augmented reality content may be generated based on the updated project modeling data. The context subsystem 118 may provide the augmented reality content to a user device during an augmented reality presentation of a real-world environment by the user device. The user device (to which the augmented reality content is provided) may be a user device from which the annotation (used to update the project modeling data) is received, a user device in or within proximity of the real-world environment, or other user device. The augmented reality content may be provided at the user device for presentation during the augmented reality presentation. As an example, upon receipt, the augmented reality content may be overlaid on the live view of the real-world environment in the augmented reality presentation. In this way, for example, the system 100 provides an augmented reality experience that enables a user to experience aspects of a working project model in the real-world environment, as well as interact with and update the project model in one or more embodiments.

In an embodiment, the creation, modification, or removal of action items, events, conversations, documents, or other project items may be facilitated via an augmented reality experience. In an embodiment, upon receipt of an annotation provided during an augmented reality presentation of a real-world environment, the context subsystem 118 may add an action item, event, conversation, document, or other item to a project (related to the real-world environment) based on the annotation. In an embodiment, if the item already exists and is associated with the project, the context subsystem 118 may modify the item or remove the item from the project based on the annotation. As an example, if the annotation comprises the input “Buy Brand X refrigerator in Color Y,” the context subsystem 118 may perform natural language processing on the annotation to detect the action “Buy” and the parameters “refrigerator,” “Brand X,” and “Color Y,” and generate the action item based on the detected action and parameters. As another example, if the annotation comprises the input “What kind of refrigerator should we buy?,” the context subsystem 118 may perform natural language processing on the annotation to detect the need for a meeting to discuss the refrigerator or other kitchen appliances and generate a calendar invite for the meeting based thereon. If, for example, a meeting to discuss other kitchen appliances already exists, the meeting (or the calendar invite thereof) may be modified to include a discussion regarding the refrigerator.

In an embodiment, the creation, modification, or removal of model objects may be facilitated via the augmented reality experience. In an embodiment, upon receipt of an annotation provided during an augmented reality presentation of a real-world environment, the context subsystem 118 may process the annotation and identify a request to add an object corresponding to a real-world object (for the real-world environment) to a project model (e.g., associated with the real-world environment). Based on the identification of the request, the context subsystem 118 may update the project model to reflect the request by adding the corresponding object to the project model. As an example, if the annotation comprises the input “Buy Brand X refrigerator in Color Y,” the context subsystem 118 may perform natural language processing on the annotation to detect the action “Buy” and the parameters “refrigerator,” “Brand X,” and “Color Y,” and predict from the detected action and parameters that a Brand X refrigerator in Color Y is desired in the kitchen. Based on the prediction, the model management subsystem 112 may generate an object corresponding to a Brand X refrigerator in Color Y, and add the corresponding object to the project model.

In one use case, with respect to FIG. 3C, a user may be provided with a suggestion 336 in an augmented reality presentation of the real-world environment 320 to add a real-world object to the real-world environment. In response, for instance with respect to FIG. 3D, the user may interact with one or more aspects in the augmented reality presentation to add augmented reality content 338 representing the suggested real-world object (e.g., Coffee Table X) to the augmented reality presentation. In a further use case, when the augmented reality presentation is updated to overlay the additional augmented reality content 338 on the live view of the real-world environment 320, other related augmented reality content 340 (e.g., the name and description of Coffee Table X) may be overlaid on the live view to supplement the additional augmented reality content 338. As such, the user may see how the suggested real-world object (e.g., Coffee Table X) might look with other real-world objects in the real-world environment 320 before requesting that the suggested real-world object be added to the real-world environment 320 (or before requesting that the suggested real-world object be considered for addition to the real-world environment).

In yet another use case, with respect to FIG. 3E, if the user initiates such a request via the augmented reality presentation, the context subsystem 117 may obtain the request and, in response, update a project model associated with the real-world environment to reflect the request by adding an object (corresponding to the suggested real-world object) to the project model. As an example, when a computer-simulated environment 350 (generated based on the updated project model) is subsequently accessed and explored by a user (e.g., via user avatar 351), the computer-simulated environment 350 may comprise objects corresponding to real-world objects in the real-world environment 320 (e.g., objects 352 and 354 or other objects) as well as objects corresponding to real-world objects that are to be added (or considered for addition) to the real-world environment (e.g., object 356 corresponding to a coffee table).

In an embodiment, upon receipt of an annotation (e.g., provided during an augmented reality presentation of a real-world environment), the context subsystem 118 may process the annotation and identify a request to modify an object (corresponding to a real-world object for the real-world environment) within a project model or remove the object from the project model. Based on the identification of the request, the context subsystem 118 may update the project model to reflect the request by modifying the object or removing the object from the project model. As an example, if the annotation comprises the input “Let's get Brand X refrigerator in Color Y instead,” the context subsystem 118 may perform natural language processing on the annotation to detect the action “Change” (e.g., from the words “Get” and “Instead”) and the parameters “refrigerator,” “Brand X,” and “Color Y,” and predict from the detected action and parameters that a Brand X refrigerator in Color Y is desired in the kitchen in lieu of another refrigerator (e.g., another pre-selected refrigerator corresponding to a refrigerator object in the project model). Based on the prediction, the model management subsystem 112 may modify the corresponding object in the project model to comprise attributes reflecting a Brand X refrigerator in Color Y. Alternatively, the model management subsystem 112 may remove the corresponding object from the project model, and add a new object corresponding to a Brand X refrigerator in Color Y to replace the removed object in the project model.

In an embodiment, the context subsystem 118 may generate augmented reality content such that the augmented reality content comprises an annotation that was provided by a user (e.g., via an augmented reality interaction, via a computer-simulated environment interaction, etc.). As an example, the annotation may be utilized to update project modeling data associated with a project model (e.g., by associating the annotation with one or more objects or other aspects of the project model). The context subsystem 118 may extract the annotation from the updated project modeling data to generate augmented reality content associated with the project model or the real-world environment such that the generated content comprises the extracted annotation. The context subsystem 118 may provide the annotation (e.g., as part of the augmented reality content) to a user device for an augmented reality presentation of a real-world environment, where the annotation may be overlaid on a live view of the real-world environment in the augmented reality presentation.

In an embodiment, the context subsystem 118 may generate augmented reality content such that the augmented reality content comprises (i) a mechanism to access an image or video related to an object in a project model, (ii) a mechanism to enable a transaction for a product or service related to the object, (iii) a mechanism to access an action item, event, conversation, or document related to the object, or (iv) other content.

In an embodiment, based on annotation provided by a user, the context subsystem 118 may identify a real-world object (related to an aspect in a live view of a real-world environment) that is to be added or modified with respect to the real-world environment. As an example, upon processing the annotation, the context subsystem 118 may identify a request to add or modify the real-world object in the annotation. Based on the request, the model management subsystem 112 may update project modeling data associated with a project model to add an object corresponding to the real-world object to the project model or modify the corresponding object with respect to the project model. In an embodiment, the context subsystem 118 may generate augmented reality content based on the added or modified object to comprise (i) a mechanism to access an image or video related to the added or modified object, (ii) a mechanism to enable a transaction for a product or service related to the added or modified object, (iii) a mechanism to access an action item, event, conversation, or document related to the added or modified object, or (iv) other content. As an example, the context subsystem 118 may provide the augmented reality content to a user device for an augmented reality presentation of the real-world environment, where one or more of the foregoing mechanisms may be overlaid on a live view of the real-world environment in the augmented reality presentation.

In an embodiment, based on an annotation provided by a user, the context subsystem 118 may identify a real-world object (related to an aspect in a live view of a real-world environment) that is to be removed with respect to the real-world environment. As an example, upon processing the annotation, the context subsystem 118 may identify a request to remove the real-world object with respect to the real-world environment in the annotation. Based on the request, the model management subsystem 112 may update the project modeling data to reflect the removal of the real-world object (e.g., by removing an object corresponding to the real-world object from the project model, by modifying an attribute of the corresponding object to indicate the requested removal, etc.).

In an embodiment, based on a processing of an annotation provided by a user (e.g., via an augmented reality interaction, via a computer-simulated environment interaction, etc.), the context subsystem 118 may identify a reference to a product or service related to an object in a project model. Based on the product or service reference, the context subsystem 118 may obtain an image, video, or other content related to the product or service (e.g., content depicting or describing the product or service), and update project modeling data associated with the project model to include the obtained content (e.g., by associating the obtained content with the object, by modifying the annotation to include the obtained content and associating the annotation with the object, etc.). When generating augmented reality content for an augmented reality presentation of a real-world environment (e.g., to which the project model corresponds), the context subsystem 118 may extract the image, video, or other content related to the product or service from the updated project modeling data to generate the augmented reality content such that the augmented reality content comprise the extracted content. The context subsystem 118 may provide the augmented reality content to a user device for the augmented reality presentation of the real-world environment. As an example, where the extracted content comprises an image of the product or service, the product or service image may be overlaid on a live view of the real-world environment in the augmented reality presentation. As another example, where the extracted content comprises a video of the product or service, the product or service video may be overlaid on a live view of the real-world environment in the augmented reality presentation.

In an embodiment, based on the identification of a reference to a product or service (related to an object in a project model) in an annotation, the context subsystem 118 may generate a mechanism to enable a transaction for the product or service (e.g., the mechanism may comprise a hyperlink to a merchant web page offering the product or service for sale, embedded code for a “buy” button or a shopping cart for purchasing the product or service, etc.). Additionally, or alternatively, the context subsystem 118 may generate a mechanism to access an action item, event, conversation, or document related to the object. The context subsystem 118 may then update project modeling data associated with a project model to include the generated mechanism (e.g., by associating the generated mechanism with the object, by modifying the annotation to include the generated mechanism and associating the annotation with the object, etc.). When generating augmented reality content for an augmented reality presentation of a real-world environment (e.g., to which the project model corresponds), the context subsystem 118 may extract the generated mechanism from the updated project modeling data to generate the augmented reality content such that the augmented reality content comprise the extracted mechanism. The context subsystem 118 may provide the augmented reality content to a user device for the augmented reality presentation of the real-world environment, where the extracted mechanism may be overlaid on a live view of the real-world environment in the augmented reality presentation.

### EXAMPLES FLOWCHARTS

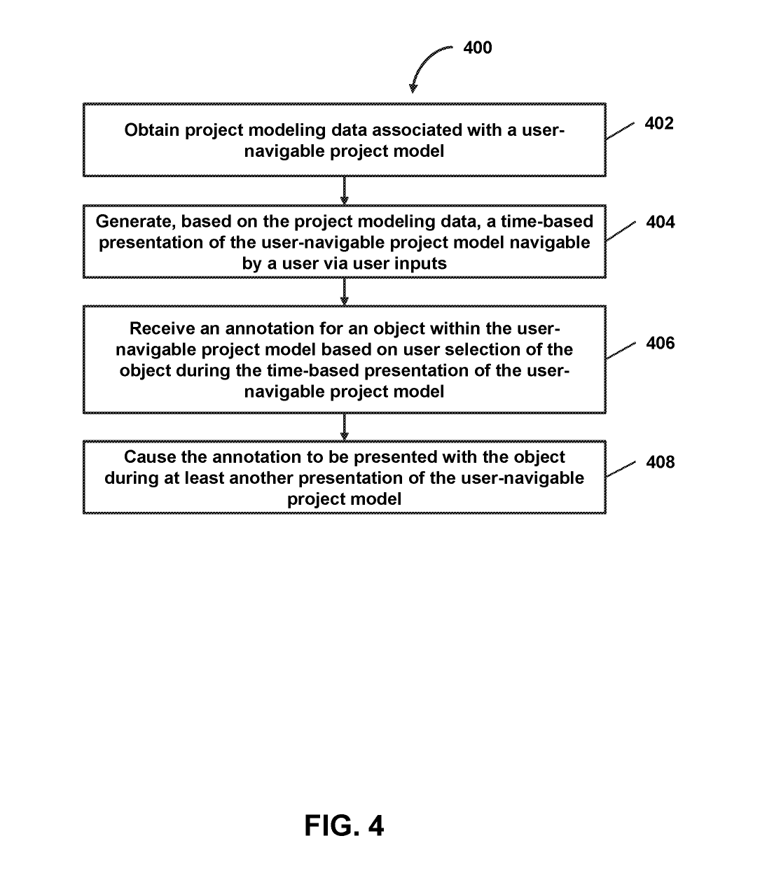

FIGS. 4-7 comprise example flowcharts of processing operations of methods that enable the various features and functionality of the system as described in detail above. The processing operations of each method presented below are intended to be illustrative and non-limiting. In some embodiments, for example, the methods may be accomplished with one or more additional operations not described, and/or without one or more of the operations discussed. Additionally, the order in which the processing operations of the methods are illustrated (and described below) is not intended to be limiting.

In some embodiments, the methods may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on an electronic storage medium. The processing devices may include one or more devices configured through hardware, firmware, and/or software to be specifically designed for execution of one or more of the operations of the methods.

FIG. 4 is flow chart of a method 400 for providing a time-based user-annotated presentation of a user-navigable project model, in accordance with one or more embodiments.

In an operation 402, project modeling data associated with a user-navigable project model may be obtained. As an example, the project modeling data may comprise (i) data indicating one or more objects associated with the project model (e.g., model objects corresponding to real-world objects for the real-world environment), (ii) data indicating one or more user-provided annotations associated with the objects, (iii) data indicating one or more locations within the project model that objects or annotations are to be presented (or otherwise accessible to a user), (iv) data indicating one or more locations within the real-world environment that real-world objects are to be placed, (v) data indicating one or more locations within the real-world environment that annotations are to be presented (or otherwise accessible to a user), (vi) data indicating one or more times at which objects or annotations are to be presented (or otherwise accessible to a user) during a presentation of the project model, (vii) data indicating one or more times at which annotations are to be presented (or otherwise accessible to a user) during an augmented reality presentation, or (viii) other project modeling data. The project modeling data may, for example, be obtained from storage, such as from project model database 132 or other storage. Operation 402 may be performed by a model management subsystem that is the same as or similar to model management subsystem 112, in accordance with one or more embodiments.

In an operation 404, a time-based presentation of the user-navigable project model may be generated based on the projecting modeling data. The time-based presentation of the user-navigable project model may be generated such that the user-navigable project model is navigable by a user via user inputs for navigating through the user-navigable project model. As an example, the time-based presentation of the user-navigable project model may comprise a computer-simulated environment of the user-navigable project model in which one, two, three, or more dimensions of the computer-simulated environment are navigable by the user. In another use case, the computer simulated environment of the user-navigable project model may be navigable by the user via a first-person or third-person view. Operation 404 may be performed by a presentation subsystem that is the same as or similar to presentation subsystem 114, in accordance with one or more embodiments.

In an operation 406, an annotation for an object within the user-navigable project model may be received based on user selection of the object during the time-based presentation of the user-navigable project model. Operation 406 may be performed by an annotation subsystem that is the same as or similar to annotation subsystem 116, in accordance with one or more embodiments.

In an operation 408, the annotation may be caused to be presented with the object during at least another presentation of the user-navigable project model. Operation 408 may be performed by a presentation subsystem that is the same as or similar to presentation subsystem 114, in accordance with one or more embodiments.

In an embodiment, with respect to operation 408, the annotation may be referenced to coordinates with respect to the user-navigable project model, and the annotation may be caused to be presented with the object during at least another presentation of the user-navigable project model based on the referenced coordinates.

In an embodiment, with respect to operation 408, the annotation may be referenced to a time reference corresponding to a time related to the receipt of the annotation during the time-based presentation of the user-navigable project model, and the annotation may be caused to be presented with the object during at least another presentation of the user-navigable project model based on the time reference.

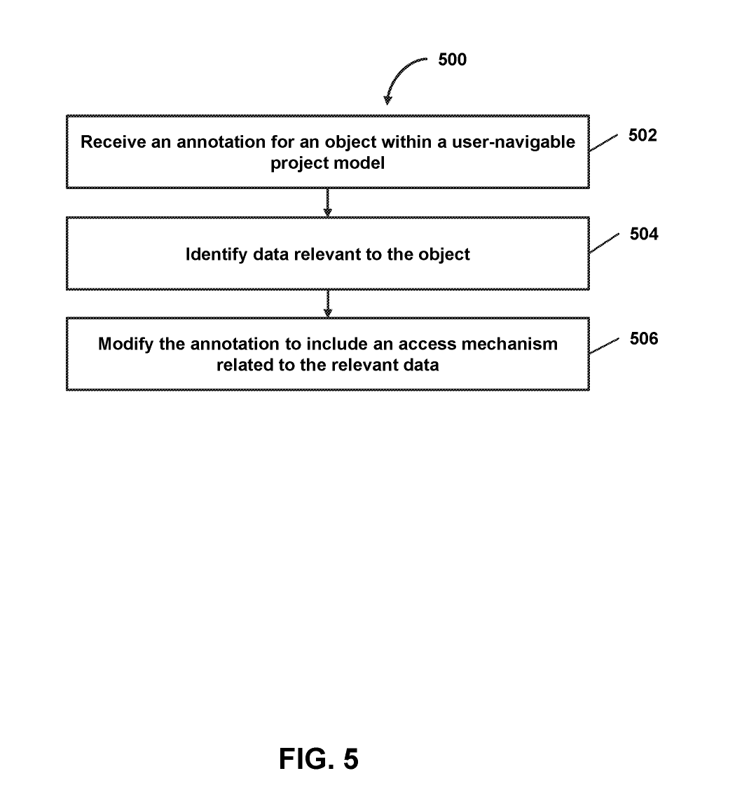

FIG. 5 is a flowchart of a method 500 for modifying an annotation provided for an object of a user-navigable project model, in accordance with one or more embodiments.

In an operation 502, an annotation may be received for an object of a user-navigable project model. As an example, the annotation may be received based on user selection of the object during a time-based presentation of the user-navigable project model. As another example, the annotation may be received based on user selection of the object before or after the time-based presentation of the user-navigable project model. The annotation may be manually entered by a user for the object, or automatically determined for the object based on interactions of the user with the object, interactions of the user with other objects, interactions of the user with other project models, or other parameters. Operation 502 may be performed by an annotation subsystem that is the same as or similar to annotation subsystem 116, in accordance with one or more embodiments.

In an operation 504, data relevant to the object may be identified. As an example, one or more images, videos, or other content related to the object may be identified based on information in the annotation (e.g., one or more references to products or services related to the object, one or more words, phrases, links, or other content related to the object, etc.), other annotations associated with the object (e.g., an annotation identifying a user that added or modified the object, an annotation identifying a time that the object was added or modified, an annotation identifying a location of the object within the user-navigable project model or relative to other objects of the user-navigable project model, etc.), or other information related to the object. As another example, one or more references to products or services related to the object may be identified. In one use case, the annotation may be processed to identify, in the annotation, a reference to a product or service related to the object. Operation 504 may be performed by a context subsystem that is the same as or similar to context subsystem 118, in accordance with one or more embodiments.

In an operation 506, the annotation may be modified to include an access mechanism related to the relevant data. As an example, based on identification of an image, video, or other content related to the object, the annotation may be modified to include a mechanism to access the image, video, or other content related to the object (e.g., the mechanism may comprise a hyperlink to the content, embedded code that causes the content to be presented when the annotation is presented, etc.). As another example, based on identification of a reference to a product or service (e.g., related to the object) in the annotation, the annotation may be modified to include a mechanism to enable a transaction for the product or service (e.g., the mechanism may comprise a hyperlink to a merchant web page offering the product or service for sale, embedded code for a “buy” button or a shopping cart for purchasing the product or service, etc.). Operation 506 may be performed by an annotation subsystem that is the same as or similar to annotation subsystem 116, in accordance with one or more embodiments.

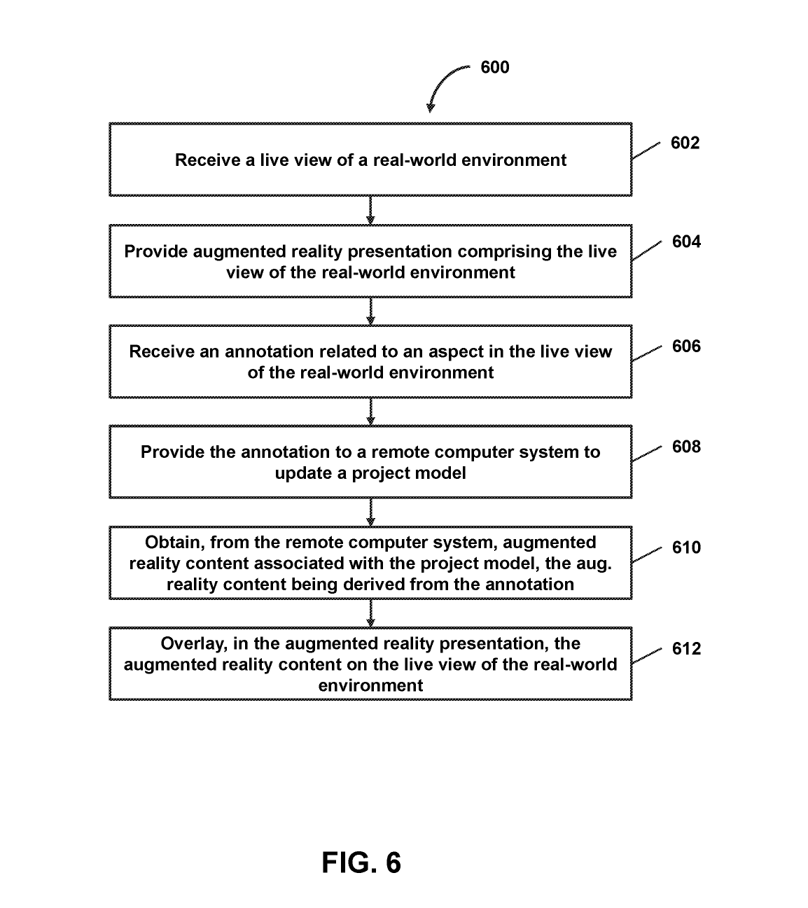

FIG. 6 is flow chart of a method 600 for facilitating augmented-reality-based interactions with a project model, in accordance with one or more embodiments.

In an operation 602, a live view of a real-world environment may be received. As an example, the live view of the real-world environment may be received via an image capture device of a user device (e.g., an image capture device of image capture subsystem 172). Operation 602 may be performed by an image capture subsystem that is the same as or similar to image capture subsystem 172, in accordance with one or more embodiments.

In an operation 604, an augmented reality presentation of the real-world environment may be provided, where the augmented reality presentation comprises the live view of the real-world environment. As an example, the augmented reality presentation may comprise the live view of the real-world environment whose aspects are augmented with visual or audio representations of context related to those or other aspects in live view of the real-world environment. Operation 604 may be performed by a user device presentation subsystem that is the same as or similar to user device presentation subsystem 178, in accordance with one or more embodiments.

In an operation 606, an annotation related to an aspect in the live view of the real-world environment may be received. As an example, the annotation may be received based on user selection of the aspect during the augmented reality presentation of the real-world environment. Operation 606 may be performed by an augmented reality subsystem that is the same as or similar to augmented reality subsystem 176, in accordance with one or more embodiments.

In an operation 608, the annotation may be provided to a remote computer system to update a project model. As an example, the project model may be associated with the real-world environment. In one use case, for example, the project model may comprise project modeling data corresponding to one or more aspects of the real-world environment. The project model may comprise a building information model, a construction information model, a vehicle information model, or other project model. Operation 608 may be performed by an augmented reality subsystem that is the same as or similar to augmented reality subsystem 176, in accordance with one or more embodiments.

In an operation 610, augmented reality content associated with the project model may be obtained from the remote computer system, where the augmented reality content is derived from the annotation provided to the remote computer system. As an example, the remote computer system may update project modeling data associated with the project model based on the annotation. The remote computer system may then generate augmented reality content based on the updated project modeling data, after which the augmented reality content may be obtained from the remote computer system. Operation 610 may be performed by an augmented reality subsystem that is the same as or similar to augmented reality subsystem 176, in accordance with one or more embodiments.

In an operation 612, the augmented reality content may be overlaid in the augmented reality presentation on the live view of the real-world environment. Operation 612 may be performed by an augmented reality subsystem that is the same as or similar to augmented reality subsystem 176, in accordance with one or more embodiments.

In an embodiment, with respect to operations 610 and 612, position information indicating a position of the user device may be obtained, and the augmented reality presentation of the real-world environment may be provided based on the position information such that the augmented reality content is obtained and overlaid on the live view of the real-world environment based on the position information. In an embodiment, the position information may be provided to the remote computer system to obtain content for the augmented reality presentation related to the position of the user device. In an embodiment, the position information may comprise location information indicating a location of the user device, and the augmented reality presentation of the real-world environment may be provided based on the location information such that the augmented reality content is obtained and overlaid on the live view of the real-world environment in the augmented reality presentation based on the location information. In an embodiment, the position information may comprise orientation information indicating an orientation of the user device, and the augmented reality presentation of the real-world environment may be provided based on the orientation information.

In an embodiment, with respect to operations 610 and 612, the augmented reality content may be the annotation, and the annotation may be obtained and overlaid on the live view of the real-world environment in the augmented reality presentation. In an embodiment, the augmented reality content may comprise content derived from the annotation, and the derived content may be obtained and overlaid on the live view of the real-world environment in the augmented reality presentation. As an example, the derived content may comprise (i) a mechanism to access an image or video related to the aspect in the live view of the real-world environment, (ii) a mechanism to enable a transaction for a product or service related to the annotation, (iii) a mechanism to access an action item, event, conversation, or document related to the annotation, or (iv) other content.

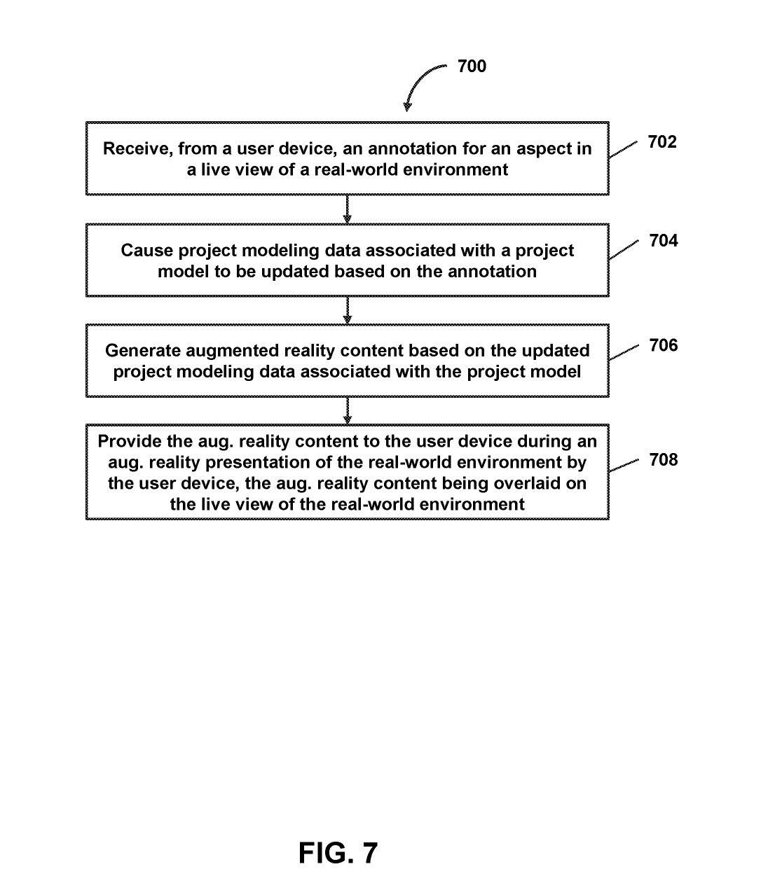

FIG. 7 is flow chart of a method 700 for facilitating augmented-reality-based interactions with a project model by providing, to a user device, augmented reality content generated based on a user-provided annotation for an aspect in a live view of a real-world environment, in accordance with one or more embodiments.

In an operation 702, an annotation for an aspect in a live view of a real-world environment may be received from a user device. As an example, the live view of the real-world may comprise a view from the perspective of the user device obtained by the user device via an image capture device of the user device. Operation 702 may be performed by an annotation subsystem that is the same as or similar to annotation subsystem 116, in accordance with one or more embodiments.

In an operation 704, project modeling data associated with a project model may be caused to be updated based on the annotation. As an example, the project model may be associated with the real-world environment. In one use case, for example, the project model may comprise project modeling data corresponding to one or more aspects of the real-world environment. The project model may comprise a building information model, a construction information model, a vehicle information model, or other project model. Operation 704 may be performed by a model management subsystem that is the same as or similar to model management subsystem 112, in accordance with one or more embodiments.

In an operation 706, augmented reality content may be generated based on the updated project modeling data associated with the project model. As an example, the augmented reality content may be generated or stored for presentation with a live view of the real-world environment to which the project model is associated. Operation 704 may be performed by a context subsystem that is the same as or similar to context subsystem 118, in accordance with one or more embodiments.

In an operation 708, the augmented reality content may be provided to the user device during an augmented reality presentation of the real-world environment by the user device. As an example, upon providing the augmented reality content, the user device may overlay the augmented reality content on the live view of the real-world environment. Operation 708 may be performed by a presentation subsystem that is the same as or similar to presentation subsystem 114, in accordance with one or more embodiments.

In an embodiment, with respect to operation 706, the augmented reality content (generated based on the updated project modeling data) may be provided to one or more other user devices. As an example, during an augmented reality presentation of the real-world environment by the other user device, the other user device may overlay the augmented reality content on a live view of the real-world environment that is from the perspective of the other user device.

In an embodiment, with respect to operation 708, position information indicating a position of the user device may be obtained, and the augmented reality content may be provided to the user device based on the position information (e.g., location information indicating a location of the user device, orientation information indicating an orientation of the user device, or other information). In an embodiment, the position information may be received from the user device to which the augmented reality content is provided.

In an embodiment, with respect to operation 702, upon receipt of the annotation, an action item, event, conversation, document, or other item may be added to a project (to which the project model is associated) based on the annotation. In an embodiment, an action item, event, conversation, document, or other item associated with the project may be modified or removed from the project based on the annotation.

In an embodiment, with respect to operation 702, upon receipt of the annotation, the annotation may be processed, and a request to add an object corresponding to a real-world object (for the real-world environment) to the project model may be identified, and the project model may be updated to reflect the request by adding the object to the project model. In an embodiment, upon processing the annotation, a request to modify an object (corresponding to the real-world object for the real-world environment) within the project model or remove the object from the project model may be identified, and the project model may be updated to reflect the request by modifying the object or removing the object from the project model.

In an embodiment, with respect to operations 706 and 708, the augmented reality content may be generated to comprise the annotation such that the annotation is overlaid on the live view of the real-world environment in the augmented reality presentation.

In an embodiment, with respect to operations 704, 706, and 708, a real-world object (related to the aspect in the live view of the real-world environment) that is to be added or modified with respect to the real-world environment may be identified based on the annotation. As an example, upon processing the annotation, a request to add or modify the real-world object may be identified in the annotation. The project modeling data may be updated based on the identification of the real-world object (e.g., indicated in the request) to add an object corresponding to the real-world object to the project model or modify the corresponding object with respect to the project model. In an embodiment, the augmented reality content may be generated based on the added or modified object to comprise (i) a mechanism to access an image or video related to the added or modified object, (ii) a mechanism to enable a transaction for a product or service related to the added or modified object, (iii) a mechanism to access an action item, event, conversation, or document related to the added or modified object, or (iv) other content. As an example, as a result of generating the augmented reality content to comprise the foregoing content, the foregoing content is overlaid on the live view of the real-world environment in the augmented reality presentation.

In an embodiment, with respect to operation 704, a real-world object (related to the aspect in the live view of the real-world environment) that is to be removed with respect to the real-world environment may be identified based on the annotation. As an example, upon processing the annotation, a request to remove the real-world object with respect to the real-world environment may be identified in the annotation. The project modeling data may be updated to reflect the removal of the real-world object (e.g., by removing an object corresponding to the real-world object from the project model, by modifying an attribute of the corresponding object to indicate the requested removal, etc.).

In some embodiments, the various computers and subsystems illustrated in FIG. 1A may comprise one or more computing devices that are programmed to perform the functions described herein. The computing devices (e.g., servers, user devices, or other computing devices) may include one or more electronic storages (e.g., project model database 132 or other electric storages), one or more physical processors programmed with one or more computer program instructions, and/or other components. In some embodiments, the computing devices may include communication lines or ports to enable the exchange of information with a network (e.g., network 150) or other computing platforms via wired or wireless techniques (e.g., Ethernet, fiber optics, coaxial cable, WiFi, Bluetooth, near field communication, or other technologies). The computing devices may include a plurality of hardware, software, and/or firmware components operating together to provide the functionality attributed herein to the servers. For example, the computing devices may be implemented by a cloud of computing platforms operating together as the computing devices.

The electronic storages may comprise non-transitory storage media that electronically stores information. The electronic storage media of the electronic storages may include one or both of system storage that is provided integrally (e.g., substantially non-removable) with the servers or removable storage that is removably connectable to the servers via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information received from the servers, information received from client computing platforms, or other information that enables the servers to function as described herein.

The processors may be programmed to provide information processing capabilities in the servers. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent processing functionality of a plurality of devices operating in coordination. The processors may be programmed to execute computer program instructions to perform functions described herein of subsystems 112-118, 172-178, or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems 112-118 described herein is for illustrative purposes, and is not intended to be limiting, as any of subsystems 112-118 or 172-178 may provide more or less functionality than is described. For example, one or more of subsystems 112-118 or 172-178 may be eliminated, and some or all of its functionality may be provided by other ones of subsystems 112-118 or 172-178. As another example, additional subsystems may be programmed to perform some or all of the functionality attributed herein to one of subsystems 112-118 or 172-178.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

1. A system for providing a time-based computer-simulated environment representative of a project model, the system comprising:
a computer system comprising one or more processor units configured by machine-readable instructions to:
obtain project modeling data associated with a project model;
generate, based on the project modeling data, a time-based computer-simulated environment representative of the project model in which two or more dimensions of the computer-simulated environment are navigable by a user via user inputs for navigating through the computer-simulated environment while the computer-simulated environment is set to automatically change in accordance with the current time of the computer-simulated environment;
provide the computer-simulated environment of the project model for presentation to the user;
receive an annotation for an object in the computer-simulated environment of the project model based on user selection of the object during the time based presentation of the computer-simulated environment of the project model while the computer-simulated environment is set to automatically change in accordance with the current time of the computer-simulated environment;
perform natural language processing on the annotation to identify data relevant to the object, the identified object-relevant data not being included in the annotation as received;
modify the annotation to include the identified object-relevant data; and
cause the modified annotation to be presented with the object during the presentation of the computer-simulated environment of the project model such that the identified object-relevant data is presented with the object during the presentation of the computer-simulated environment.

2. The system according to claim 1, wherein the one or more processor units are configured to:
perform natural language processing on one or more action items originating outside of the computer-simulated environment of the project model;
identify, based on the natural language processing on the one or more action items, data relevant to the one or more action items, the identified action-item-relevant data not being included in content of the one or more action items that is provided as input for performing the natural language processing on the one or more action items; and
cause the identified action-item-relevant data to be represented in the computer-simulated environment of the project model such that the identified action-item-relevant data is represented during the presentation of the computer-simulated environment.

3. The system according to claim 1, wherein the one or more processor units are configured to:
perform natural language processing on one or more conversations recorded outside of the computer-simulated environment of the project model during a chat session or a telephonic session;
identify, based on the natural language processing on the one or more conversations, data relevant to the one or more conversations, the identified conversation-relevant data not being included in the one or more conversations as recorded; and
cause the identified conversation-relevant data to be represented in the computer-simulated environment of the project model such that the identified conversation-relevant data is represented during the presentation of the computer-simulated environment.

4. The system according to claim 1, wherein the computer-simulated environment of the project model is navigable by the user via a first-person or third-person view of an avatar representing the user.

5. The system according to claim 1, wherein the one or more processor units are configured to:
reference the modified annotation to coordinates with respect to the project model; and
cause the modified annotation to be presented with the object during at least another presentation representative of the computer-simulated environment of the project model based on the referenced coordinates.

6. The system according to claim 1, wherein the one or more processor units are configured to:
reference the modified annotation to a time reference corresponding to a time related to the receipt of the annotation during the presentation of the computer-simulated environment of the project model; and
cause the modified annotation to be presented with the object during at least another presentation representative of the computer-simulated environment of the project model based on the time reference.

7. The system according to claim 1, wherein the one or more processor units are configured to:
identify, based on the natural language processing on the annotation, a mechanism that enables a transaction for a product or service related to the object, the mechanism that enables the project or service transaction not being included in the annotation as received,
wherein the one or more processor units modify the annotation by modifying the annotation to include the mechanism that enables the project or service transaction such that the mechanism that enables the product or service transaction is presented with the object during the presentation of the computer-simulated environment of the project model.

8. The system according to claim 1, wherein the one or more processor units are configured to:
identify, based on the natural language processing on the annotation, a mechanism to assess an image or video related to the object, neither the object-related image or video nor the mechanism to assess the object-related image or video being included in the annotation as received; and
wherein the one or more processor units modify the annotation by modifying the annotation to include the mechanism to assess the object-related image or video such that the mechanism to assess the object-related image or video is presented with the object during the presentation of the computer-simulated environment of the project model.

9. The system according to claim 1, wherein the one or more processor units are configured to:
identify, based on the natural language processing on the annotation, a mechanism that enables a transaction for a product or service related to the object, the mechanism that enables the project or service transaction not being included in the annotation as received,
wherein the one or more processor units modify the annotation by modifying the annotation to include the mechanism that enables the project or service transaction such that the mechanism that enables the product or service transaction is presented with the object during the presentation of the computer-simulated environment of the project model.

10. The system according to claim 1, wherein the one or more processor units are configured to:
identify, based on the natural language processing on the annotation, an indication to modify or delete one or more action items, conversations, events, or documents originating outside of the computer-simulated environment of the project model; and
modify or delete the one or more action items, conversations, events, or documents based on the identified modification or deletion indication.

11. The system according to claim 7, claim 1, wherein the one or more processor units are configured to:
generate, based on the natural language processing on the annotation, an action item related to the object,
wherein the one or more processor units modify the annotation by modifying the annotation to include a mechanism to access the object-related action item such that the mechanism to access the object-related action item is presented with the object during the presentation of the computer-simulated environment of the project model.

12. The system according to claim 1, wherein the one or more processor units are configured to:
initiate, based on the natural language processing on the annotation, a conversation related to the object that is to be between at least two entities,
wherein the one or more processor units modify the annotation by modifying the annotation to include a mechanism to access the object-related conversation between the two entities such that the mechanism to access the object-related conversation is presented with the object during the presentation of the computer-simulated environment of the project model.

13. The system according to claim 1, wherein the one or more processor units are configured to:
generate, based on the natural language processing on the annotation, one or more events or documents related to the object,
wherein the one or more processor units modify the annotation by modifying the annotation to include a mechanism to access the one or more object-related events or documents such that the mechanism to access the one or more object-related events or documents is presented with the object during the presentation of the computer-simulated environment of the project model.

14. The system according to claim 13, claim 1, wherein the one or more processor units are configured to:
generate, based on the natural language processing on the annotation, an action item related to the object; and
cause the project model to be updated with the object-related action item such that the object-related action item is added to a project associated with the project model.

15. The system according to claim 13, wherein the one or more processor units are configured to:
initiate, based on the natural language processing on the annotation, a conversation related to the object that is to be between at least two entities; and
cause the project model to be updated with the object-related conversation between the two entities such that the object-related conversation is added to a project associated with the project model.

16. The system according to claim 1, wherein the user navigable project model comprises a building information model, a construction information model, or a vehicle information model.

17. A method for providing a time-based computer-simulated environment representative of a project model, the method being implemented by a computer system comprising one or more processor units executing computer program instructions which, when executed, perform the method, the method comprising:
obtaining project modeling data associated with a project model;
generating, based on the project modeling data, a time-based computer-simulated environment representative of the project model in which two or more dimensions of the computer-simulated environment are navigable by a user via user inputs for navigating through the computer-simulated environment while the computer-simulated environment is set to automatically change in accordance with the current time of the computer-simulated environment;
providing the computer-simulated environment of the project model for presentation to the user;
receiving an annotation for an object in the computer-simulated environment of the project model based on user selection of the object during the presentation of the computer-simulated environment of the project model while the computer-simulated environment is set to automatically change in accordance with the current time of the computer-simulated environment;
performing natural language processing on the annotation to identify data relevant to the object, the identified object-relevant data not being included in the annotation as received;
modifying the annotation to include the identified object-relevant data; and
causing the modified annotation to be presented with the object during the presentation of the computer-simulated environment of the project model such that the identified object-relevant data is presented with the object during the presentation of the computer-simulated environment.

18. The method according to claim 17, further comprising:
performing natural language processing on one or more action items originating outside of the computer-simulated environment of the project model;
identifying, based on the natural language processing on the one or more action items, data relevant to the one or more action items, the identified action-item-relevant data not being included in content of the one or more action items that is provided as input for performing the natural language processing on the one or more action items; and
causing the identified action-item-relevant data to be represented in the computer-simulated environment of the project model such that the identified action-item-relevant data is represented during the presentation of the computer-simulated environment.

19. The method according to claim 17, further comprising:
performing natural language processing on one or more conversations recorded outside of the computer-simulated environment of the project model during a chat session or a telephonic session;
identifying, based on the natural language processing on the one or more conversations, data relevant to the one or more conversations, the identified conversation-relevant data not being included in the one or more conversations as recorded; and
causing the identified conversation-relevant data to be represented in the computer-simulated environment of the project model such that the identified conversation-relevant data is represented during the presentation of the computer-simulated environment.

20. The method according to claim 17, further comprising:
identifying, based on the natural language processing on the annotation, a mechanism that enables a transaction for a product or service related to the object, the mechanism that enables the project or service transaction not being included in the annotation as received,
wherein modifying the annotation comprises modifying the annotation to include the mechanism that enables the project or service transaction such that the mechanism that enables the product or service transaction is presented with the object during the presentation of the computer-simulated environment of the project model.

21. A system for providing a time-based computer-simulated environment representative of a project model, the system comprising:
a computer system comprising one or more processor units configured by machine-readable instructions to:
obtain project modeling data associated with a project model;
generate, based on the project modeling data, a time-based computer-simulated environment representative of the project model in which two or more dimensions of the computer-simulated environment are navigable by a user via user inputs for navigating through the computer-simulated environment while the computer-simulated environment is set to automatically change in accordance with the current time of the computer-simulated environment;
provide the computer-simulated environment of the project model for presentation to the user;
receive a request to add, modify, or remove an object in the computer-simulated environment of the project model based on user selection of the object during the presentation of the computer-simulated environment of the project model while the computer-simulated environment is set to automatically change in accordance with the current time of the computer-simulated environment;
perform natural language processing on the addition, modification, or removal request to identify which operation of adding, modifying, or removing to be performed with respect to the object; and
cause the project model to be updated to reflect the addition, modification, or removal request by performing the identified operation with respect to the object.

22. The system according to claim 21, wherein the one or more processor units are configured to:
perform natural language processing on one or more action items originating outside of the computer-simulated environment of the project model;
identify, based on the natural language processing on the one or more action items, data relevant to the one or more action items, the identified action-item-relevant data not being included in content of the one or more action items that is provided as input for performing the natural language processing on the one or more action items; and
cause the identified action-item-relevant data to be represented in the computer-simulated environment of the project model such that the identified action-item-relevant data is represented during the presentation of the computer-simulated environment.

23. The system according to claim 21, wherein the one or more processor units are configured to:
perform natural language processing on one or more conversations recorded outside of the computer-simulated environment of the project model during a chat session or a telephonic session;
identify, based on the natural language processing on the one or more conversations, data relevant to the one or more conversations, the identified conversation-relevant data not being included in the one or more conversations as recorded; and
cause the identified conversation-relevant data to be represented in the computer-simulated environment of the project model such that the identified conversation-relevant data is represented during the presentation of the computer-simulated environment.

24. The system according to claim 21, wherein the one or more processor units are configured to:
identify, based on the natural language processing on the addition, modification, or removal request, an indication to modify or delete an action item originating outside of the computer-simulated environment of the project model; and
modify or delete the action item based on the identified modification or deletion indication.

25. The system according to claim 21, wherein the one or more processor units are configured to:
identify, based on the natural language processing on the addition, modification, or removal request, an indication to modify or delete a conversation recorded outside of the computer-simulated environment of the project model during a chat session or a telephonic session; and
modify or delete the conversation based on the identified modification or deletion indication.

26. The system according to claim 21, wherein the one or more processor units are configured to:
identify, based on the natural language processing on the addition, modification, or removal request, an indication to modify or delete one or more events or documents originating outside of the computer-simulated environment of the project model; and
modify or delete the one or more events or documents based on the identified modification or deletion indication.

27. The system according to claim 21, wherein the one or more processor units are configured to:
generate, based on the natural language processing on the addition, modification, or removal request, an action item related to the object; and
cause the project model to be updated with the object-related action item such that the object-related action item is added to a project associated with the project model.

28. The system according to claim 21, wherein the one or more processor units are configured to:
initiate, based on the natural language processing on the addition, modification, or removal request, a conversation related to the object that is to be between at least two entities; and
cause the project model to be updated with the object-related conversation between the two entities such that the object-related conversation is added to a project associated with the project model.

29. The system according to claim 21, wherein the one or more processor units are configured to:
generate, based on the natural language processing on the addition, modification, or removal request, one or more events or documents related to the object; and
cause the project model to be updated with the one or more object-related events or documents such that the object-related events or documents is added to a project associated with the project model.

30. The system according to claim 21, wherein the project model comprises a building information model, a construction information model, or a vehicle information model.
